(19) United States
(12) Patent Application Publication
(10) Pub. No.: US 2024/0129957 A1
(43) Pub. Date: Apr. 18, 2024

(54) RANDOM ACCESS RESPONSE SCHEMES FOR ENHANCED REDUCED CAPABILITY (REDCAP) USER EQUIPMENT

(71) Applicant: QUALCOMM Incorporated, San Diego, CA (US)

(72) Inventors: Muhammad Nazmul ISLAM, Littleton, MA (US); Yongjun KWAK, San Diego, CA (US)

(21) Appl. No.: 18/481,118

(22) Filed: Oct. 4, 2023

Related U.S. Application Data
(60) Provisional application No. 63/414,376, filed on Oct. 7, 2022.

(51) Int. Cl. H04W 74/08; H04W 72/02

(52) U.S. Cl. CPC H04W 74/0833; H04W 72/02; H04W 74/0875

(57) ABSTRACT

Methods, systems, and devices for wireless communication are described. A first network node of a first type of UE may receive a control message indicating one or more PRACH resources to be used for random access of a second network node. Each of the one or more PRACH resources being associated with a respective one or more user equipment (UE) types. The first network node may determine that none of the indicated PRACH resources are associated with the first type of UE. The first network node may select a PRACH resource from the indicated PRACH resources in accordance with a ranking for PRACH resource selection. The first network node may transmit a random access preamble to the second network node via the selected PRACH resource.

### CROSS REFERENCE

The present Application for Patent claims the benefit of U.S. Provisional Patent Application No. 63/414,376 by ISLAM et al., entitled “RANDOM ACCESS RESPONSE SCHEMES FOR ENHANCED REDUCED CAPABILITY (REDCAP) USER EQUIPMENT,” filed Oct. 7, 2022, and assigned to the assignee hereof, and expressly incorporated by reference herein.

### INTRODUCTION

The following relates to wireless communications pertaining to random access response schemes for enhanced reduced capability (eRedCap) user equipment (UEs).

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access response schemes for enhanced reduced capability (eRedCap) user equipment (UEs). For example, the described techniques provide for receiving, at a first network node, a random access response from a second network node. The first network node may receive the random access response during a random access window associated with a random access request by the first network node. In some examples, the first network node may determine that the random access response is associated with a first UE type. The first UE type may be an enhanced RedCap (eRedCap) UE type. The first network node may decode a transport block of the random access response based on the determination and based on the first network node being the first UE type.

A method of wireless communication performed by a first network node is described. The method may include receiving a control message indicating one or more physical random access channel (PRACH) resources to be used for random access of a second network node, each of the one or more PRACH resources being associated with a respective one or more UE types, determining that none of the one or more PRACH resources included in the control message are associated with a first UE type, where the first network node is of the first UE type, and where the first UE type is an eRedCap UE type, selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources, and transmitting the random access preamble to the second network node via the selected PRACH resource of the one or more PRACH resources.

A first network node is described. The first network node may include a processing system configured to receive a control message indicating one or more PRACH resources to be used for random access of a second network node, each of the one or more PRACH resources being associated with a respective one or more UE types, determine that none of the one or more PRACH resources included in the control message are associated with a first UE type, where the first network node is of the first UE type, and where the first UE type is an eRedCap UE type, select, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources, and transmit the random access preamble to the second network node via the selected PRACH resource of the one or more PRACH resources.

Another first network node is described. The first network node may include means for receiving a control message indicating one or more PRACH resources to be used for random access of a second network node, each of the one or more PRACH resources being associated with a respective one or more UE types, means for determining that none of the one or more PRACH resources included in the control message are associated with a first UE type, where the first network node is of the first UE type, and where the first UE type is an eRedCap UE type, means for selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources, and means for transmitting the random access preamble to the second network node via the selected PRACH resource of the one or more PRACH resources.

A non-transitory computer-readable medium having code for wireless communication stored thereon is described. The code, when executed by a network node, causes the network node to receive a control message indicating one or more PRACH resources to be used for random access of a second network node, each of the one or more PRACH resources being associated with a respective one or more UE types, determine that none of the one or more PRACH resources included in the control message are associated with a first UE type, where the first network node is of the first UE type, and where the first UE type is an eRedCap UE type, select, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources, and transmit the random access preamble to the second network node via the selected PRACH resource of the one or more PRACH resources.

In some examples of the method, first network nodes, and non-transitory computer-readable medium described herein, the ranking prioritizes PRACH resources associated with a second UE type when none of the one or more PRACH resources included in the control message may be associated with the first UE type.

In some examples of the method, first network nodes, and non-transitory computer-readable medium described herein, the ranking prioritizes a default PRACH resource when none of the one or more PRACH resources included in the control message may be associated with the first UE type and none of the one or more PRACH resources included in the control message may be associated with the second UE type.

In some examples of the method, first network nodes, and non-transitory computer-readable medium described herein, the ranking prioritizes PRACH resources associated with a third UE type when none of the one or more PRACH resources included in the control message may be associated with the first UE type and none of the one or more PRACH resources included in the control message may be associated with the second UE type.

In some examples of the method, first network nodes, and non-transitory computer-readable medium described herein, the second UE type may be a RedCap UE type and the third UE type may be an enhanced mobile broadband (eMBB) UE type.

In some examples of the method, first network nodes, and non-transitory computer-readable medium described herein, the eRedCap UE type corresponds to reduced capabilities with respect to a RedCap UE type and an eMBB UE type.

In some examples of the method, first network nodes, and non-transitory computer-readable medium described herein, the first UE type may be associated with a first maximum bandwidth processing capability that may be lower than a second maximum bandwidth processing capability associated with eMBB UEs.

In some examples of the method, first network nodes, and non-transitory computer-readable medium described herein, the first maximum bandwidth processing capability pertains to one or more combinations of radio frequency bandwidth, baseband bandwidth, or bandwidth for physical downlink shared channel (PDSCH) or physical uplink shared channel (PUSCH).

Some examples of the method, first network nodes, and non-transitory computer-readable medium described herein may further include operations, features, means, or instructions for receiving a second control message indicating the ranking for the PRACH resource selection.

A method of wireless communication performed by a first network node is described. The method may include receiving a control message indicating one or more initial bandwidth parts to be used for random access of a second network node, each of the one or more initial bandwidth parts being associated with a respective one or more UE types, determining that none of the one or more initial bandwidth parts included in the control message are associated with a first UE type, where the first network node is of the first UE type, and where the first UE type is an eRedCap UE type, selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts, and transmitting a random access request to the second network node via the selected initial bandwidth part of the one or more initial bandwidth parts.

A first network node is described. The first network node may include a processing system configured to receive a control message indicating one or more initial bandwidth parts to be used for random access of a second network node, each of the one or more initial bandwidth parts being associated with a respective one or more UE types, determine that none of the one or more initial bandwidth parts included in the control message are associated with a first UE type, where the first network node is of the first UE type, and where the first UE type is an eRedCap UE type, select, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts, and transmit a random access request to the second network node via the selected initial bandwidth part of the one or more initial bandwidth parts.

Another first network node is described. The first network node may include means for receiving a control message indicating one or more initial bandwidth parts to be used for random access of a second network node, each of the one or more initial bandwidth parts being associated with a respective one or more UE types, means for determining that none of the one or more initial bandwidth parts included in the control message are associated with a first UE type, where the first network node is of the first UE type, and where the first UE type is an eRedCap UE type, means for selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts, and means for transmitting a random access request to the second network node via the selected initial bandwidth part of the one or more initial bandwidth parts.

A non-transitory computer-readable medium having code for wireless communication stored thereon is described. The code, when executed by a network node, causes the network node to receive a control message indicating one or more initial bandwidth parts to be used for random access of a second network node, each of the one or more initial bandwidth parts being associated with a respective one or more UE types, determine that none of the one or more initial bandwidth parts included in the control message are associated with a first UE type, where the first network node is of the first UE type, and where the first UE type is an eRedCap UE type, select, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts, and transmit a random access request to the second network node via the selected initial bandwidth part of the one or more initial bandwidth parts.

In some examples of the method, first network nodes, and non-transitory computer-readable medium described herein, the ranking prioritizes initial bandwidth parts associated with a second UE type when none of the one or more initial bandwidth parts included in the control message may be associated with the first UE type.

In some examples of the method, first network nodes, and non-transitory computer-readable medium described herein, the ranking prioritizes a default initial bandwidth part when none of the one or more initial bandwidth parts included in the control message may be associated with the first UE type and none of the one or more initial bandwidth parts included in the control message may be associated with the second UE type.

In some examples of the method, first network nodes, and non-transitory computer-readable medium described herein, the ranking prioritizes initial bandwidth parts associated with a third UE type when none of the one or more initial bandwidth parts included in the control message may be associated with the first UE type and none of the one or more initial bandwidth parts included in the control message may be associated with the second UE type.

In some examples of the method, first network nodes, and non-transitory computer-readable medium described herein, the second UE type may be a RedCap UE type and the third UE type may be an eMBB UE type.

In some examples of the method, first network nodes, and non-transitory computer-readable medium described herein, the eRedCap UE type corresponds to reduced capabilities with respect to a RedCap UE type and an eMBB UE type.

In some examples of the method, first network nodes, and non-transitory computer-readable medium described herein, the first UE type may be associated with a first maximum bandwidth processing capability that may be lower than a second maximum bandwidth processing capability associated with eMBB UEs.

In some examples of the method, first network nodes, and non-transitory computer-readable medium described herein, the first maximum bandwidth processing capability pertains to one or more combinations of radio frequency bandwidth, baseband bandwidth, or bandwidth for PDSCH or PUSCH.

Some examples of the method, first network nodes, and non-transitory computer-readable medium described herein may further include operations, features, means, or instructions for receiving a second control message indicating the ranking for the initial bandwidth part selection.

### BRIEF DESCRIPTION OF THE DRAWINGS

FIGS. 1 and 2 each illustrates an example of a wireless communications system that supports random access response schemes for enhanced reduced capability (eRedCap) user equipment (UEs) in accordance with one or more aspects of the present disclosure.

FIGS. 3 and 4 each illustrates an example of a process flow that supports random access response schemes for enhanced RedCap (eRedCap) UEs in accordance with one or more aspects of the present disclosure.

FIGS. 5 and 6 show block diagrams of devices that support random access response schemes for eRedCap UEs in accordance with one or more aspects of the present disclosure.

FIG. 7 shows a block diagram of a communications manager that supports random access response schemes for eRedCap UEs in accordance with one or more aspects of the present disclosure.

FIG. 8 shows a diagram of a system including a device that supports random access response schemes for eRedCap UEs in accordance with one or more aspects of the present disclosure.

FIGS. 9 and 10 show block diagrams of devices that support random access response schemes for eRedCap UEs in accordance with one or more aspects of the present disclosure.

FIG. 11 shows a block diagram of a communications manager that supports random access response schemes for eRedCap UEs in accordance with one or more aspects of the present disclosure.

FIG. 12 shows a diagram of a system including a device that supports random access response schemes for eRedCap UEs in accordance with one or more aspects of the present disclosure.

FIGS. 13 through 16 show flowcharts illustrating methods that support random access response schemes for eRedCap UEs in accordance with one or more aspects of the present disclosure.

### DETAILED DESCRIPTION

Some wireless communications systems may support multiple types of communication devices (e.g., user equipments (UEs)). For example, a wireless communications system may include higher capability UEs that support relatively low latency and relatively high data throughput communication, such as enhanced mobile broadband (eMBB) communications. Such UEs may be referred to as eMBB UEs. Additionally, or alternatively, the wireless communications system may include lower capability UEs, or reduced capability (RedCap) UEs, which may operate with one or more of a reduced transmit power, a reduced quantity of transmit or receive antennas, a reduced transmit or receive bandwidth, or a reduced computational complexity. As such, some RedCap UEs may support a reduced peak data throughput, reliability, bandwidth, or other characteristics or capabilities. In some examples, such as to support low-tier internet of things (IoT) functionality, the wireless communications system may also include eRedCap (enhanced RedCap, which may also be referred to as evolved RedCap) UEs with capabilities that may be reduced relative to RedCap UEs. Although eRedCap UEs are referred to throughout the present disclosure, it should be understood that the techniques described herein may also apply to other types of devices associated with a bandwidth processing capability that may be reduced relative to a bandwidth processing capability associated with eMBB UEs.

In some examples, eMBB UEs, RedCap UEs, and eRedCap UEs, among other UE types, may use a same set of time-frequency resources to transmit one or more messages as part of a random access procedure to establish a connection with a network entity. Such resources may be referred to as a random access occasion. For example, an eMBB UE, a RedCap UE, and an eRedCap UE may use a same random access occasion to transmit a random access request to the network entity. In such an example, each random access requests may include a preamble selected at the respective UE (e.g., the UE that transmitted the random access request). In response, the network entity may transmit a random access response to one or more of the UEs. The random access response may include, in its payload, an identifier of a UE that transmitted a random access request (e.g., the eMBB UE, the RedCap UE, or the eRedCap UE). For example, the random access response may include (e.g., indicate) an identifier corresponding to the preamble transmitted from the eRedCap UE. In some examples, however, a bandwidth supported at the eRedCap UE may be constrained, such that the eRedCap UE may be incapable of determining that a response was transmitted, or that the response may be intended for the eRedCap UE. That is, the eRedCap UE may be incapable of successfully decoding the random access response. In such an example, the eRedCap UE may retransmit the preamble to the network entity unnecessarily, which may lead to a reduced resource utilization within the wireless communications system.

Various aspects of the present disclosure generally relate to techniques for random access response schemes for eRedCap UEs, and more specifically, to schemes for transmitting random access responses to multiple UE types that support multiple (e.g., different) bandwidths. For example, a network entity may use a downlink control channel message (e.g., a grant) included in a random access response to indicate a UE type associated with the random access response. In some examples, the network entity may indicate the UE type using one or more bits (e.g., reserved bits) in a field of the downlink control channel message. For example, the UE may use one or more bits in a modulation and coding scheme (MCS) level field or a transport block scaling field (or both) to determine the UE type associated with the random access response.

Additionally, or alternatively, the network entity may use a radio network temporary identifier (RNTI) to indicate the UE type. For example, the network entity may determine an RNTI using a parameter that may be based on the UE type associated with the random access response message. In such an example, the network entity may use the determined RNTI to scramble cyclic redundancy check (CRC) bits included in the downlink control channel message. As such, the eRedCap UE and one or more other UEs may determine a UE type associated with the random access response based on the RNTI used to scramble the CRC bits. In some other examples, the network entity may configure the eRedCap UE with one or more initial bandwidth parts to be used for a random access procedure with the network entity. In such examples, each of the one or more initial bandwidth parts may be associated with a type (e.g., different types or a same type) of UE. In some examples, the eRedCap UE may select a bandwidth part to use for a random access procedure with the network entity (e.g., for transmitting a random access request) from the configured initial bandwidth parts. For example, the eRedCap UE may select a bandwidth part based on one or more rules, such as according to a selection hierarchy defined by the one or more rules.

Particular aspects of the subject matter described herein may be implemented to realize one or more potential advantages. For example, the techniques employed by the described communication devices may provide benefits and enhancements to the operation of the communication devices, including more efficient random access communications at eRedCap UEs. In some examples, operations performed by the described communication devices may also support reduced power consumption, increased throughput, and higher data rates, among other benefits.

Aspects of the disclosure are initially described in the context of wireless communications systems and process flows. Aspects of the disclosure are also illustrated by and described with reference to apparatus diagrams, system diagrams, and flowcharts that relate to random access response schemes for eRedCap UEs.

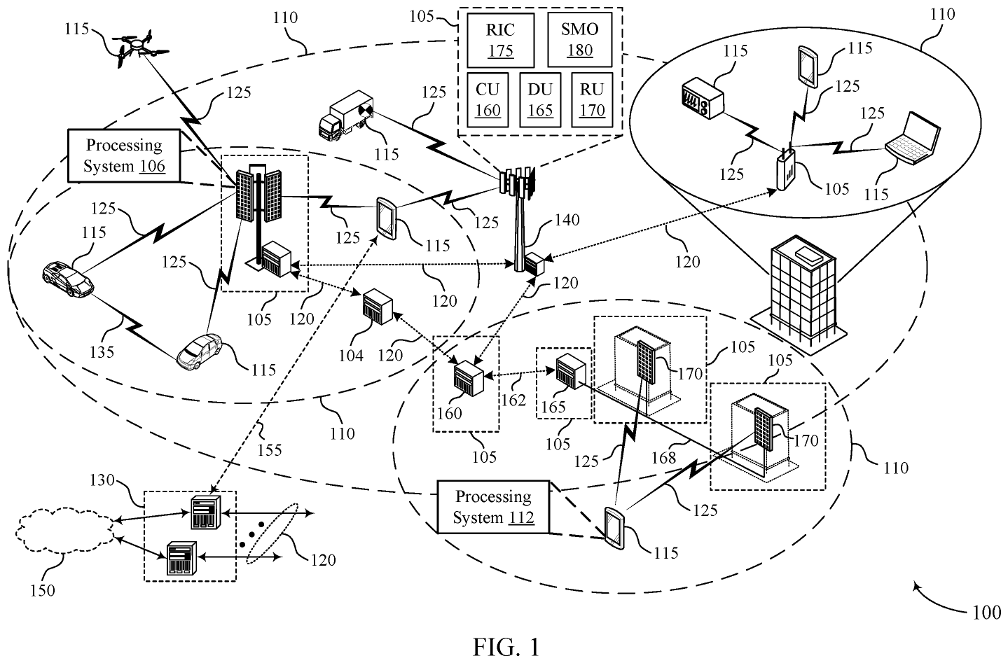

FIG. 1 illustrates an example of a wireless communications system 100 that supports random access response schemes for eRedCap UEs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (Redcap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein. For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, radio frequency functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support random access response schemes for eRedCap UEs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (bandwidth part)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the radio frequency spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a bandwidth part) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more bandwidth parts having the same or different numerologies. In some examples, a UE 115 may be configured with multiple bandwidth parts. In some examples, a single bandwidth part for a carrier may be active at a given time and communications for the UE 115 may be restricted to one or more active bandwidth parts.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed radio frequency spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support schemes for transmitting random access responses to multiple UE types that support multiple (e.g., different) bandwidths. For example, a network entity 105 may use a downlink control channel message included in a random access response to indicate a UE type associated with the random access response. In some examples, a UE 115 may receive a random access response from the network entity 105 during a random access window associated with a random access request by the UE 115. The UE 115 may determine that the random access response is associated with a first UE type. In such examples, the UE 115 may decode a transport block of the random access response based on the determination and the UE 115 being the first UE type (e.g., an eRedCap UE).

Additionally, or alternatively, the UE 115 may receive a control message indicating one or more initial bandwidth parts to be used for random access of the network entity 105, each of the one or more initial bandwidth parts being associated with a respective one or more UE types. In some examples, the UE 115 may determine that none of the one or more initial bandwidth parts included in the control message are associated with the first UE type (e.g., the first UE type corresponding to the UE 115). In such examples, the UE 115 may select a particular initial bandwidth part of the one or more initial bandwidth parts included in the control message for use in a random access procedure with the network entity 105. In some examples, the UE 115 may select the particular initial bandwidth part in accordance with a rule for initial bandwidth part selection when none of the one or more initial bandwidth parts included in the control message are associated with the first UE type. The UE 115 may transmit a random access request to the network entity 105 via the selected one of the one or more initial bandwidth parts. In some examples, transmitting the random access request using the selected one of the one or more initial bandwidth parts may lead to increased efficiency associated with random access within the wireless communications system 100, among other possible benefits.

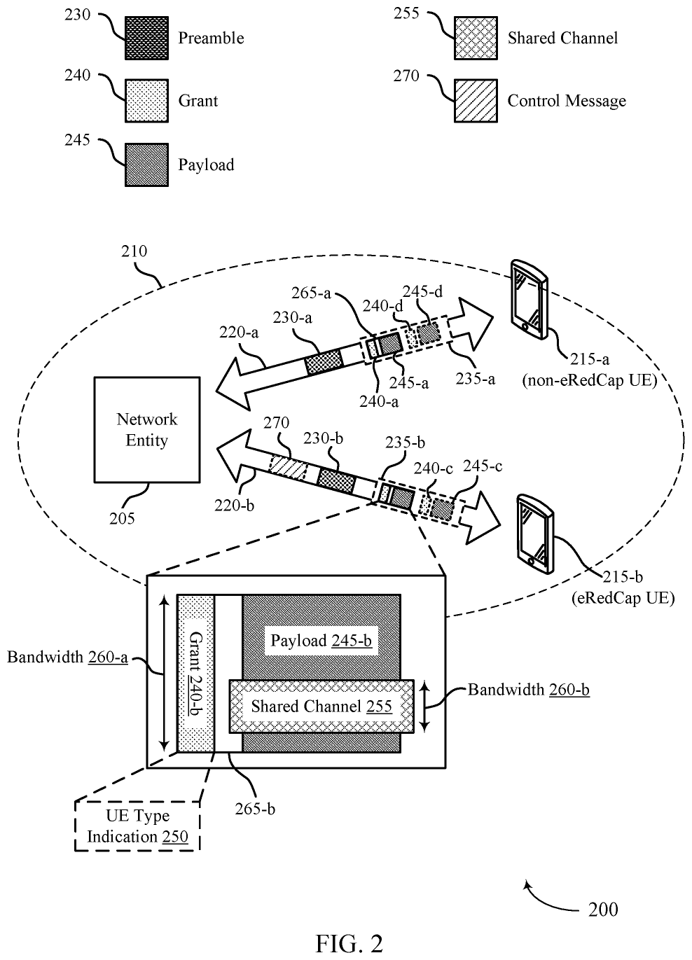

FIG. 2 illustrates an example of a wireless communications system 200 that supports random access response schemes for eRedCap UEs in accordance with one or more aspects of the present disclosure. In some examples, the wireless communications system 200 may implement or be implemented at one or more aspects of the wireless communications system 100. For example, the wireless communications system 200 may include a UE 215-a and a UE 215-b, which may be examples of a UE 115 as described with reference to FIG. 1. The wireless communications system 200 may also include a network entity 205, which may be an example of one or more of the network entities 105 (e.g., a CU, a DU, an RU, a base station, an IAB node, or one or more other network nodes) as described with reference to FIG. 1. The network entity 205 and the UEs 215 may communicate using a communication link 220-a and a communication link 220-b, which may be examples of a communication link 125 as described with reference to FIG. 1. In the example of FIG. 2, the UEs 215 and the network entity 205 may communicate within a coverage area 210, which may be an example of a coverage area 110 as described with reference to FIG. 1. The wireless communications system 200 may include features for improved communications between the network entity 205 and the UEs 215, among other possible benefits.

The wireless communications system 200 may include multiple UE types, such as smartphones (e.g., enhanced mobile broadband (eMBB) UEs), and one or more other vertical market UEs (e.g., ultra-reliable low latency communication (URLLC) UEs, V2X UEs), among other examples. Additionally, or alternatively, to achieve scalability and enable deployments in a more efficient and cost-effective manner, the wireless communications system 200 (e.g., an NR system) may include another UE type with reduced capabilities. For example, the wireless communications system 200 may include one or more RedCap UEs. In some examples, the wireless communications system 200 may support RedCap UEs by relaxing peak throughput, latency, and reliability constraints. In the example of FIG. 2, the UE 215-a may be an example of an eMBB UE or a RedCap UE, which are examples of non-eRedCap UEs. In some examples, RedCap UEs may lead to a reduction on cost, complexity, and power consumption, among other possible benefits. Additionally, or alternatively, the wireless communications system 200 may support RedCap evolution, which may consider use of another UE type with further reduced capabilities to support one or more low-tier IoT use cases. Such UEs may be referred to as eRedCap UEs. In the example of FIG. 2, the UE 215-b may be an example of an eRedCap UE. For example, the wireless communications system 200 may support coexistence between non-eRedCap UEs, such as the UE 215-a, and eRedCap UEs, such as the UE 215-b.

In some examples, eRedCap UEs (e.g., NR eRedCap UEs) may be designed to reduce (e.g., minimize) UE complexity and reduce (e.g., further save) device costs. In such examples, UE bandwidth may also be reduced relative to other UE types (e.g., from an NR baseline). For example, to reduce costs and complexity relative to the UE 215-a, the UE 215-b may support a reduced bandwidth or data rate (or both). That is, while an eMBB UE may support a bandwidth of about 100 MHz and a RedCap UE may support a bandwidth of about 20 MHz, an eRedCap UE may support a bandwidth of about 5 MHz for some communication channels. For example, the UE 215-b may support a baseband bandwidth reduction in which the UE 215-b may use about a 5 MHz baseband bandwidth for a PDSCH (e.g., for both unicast and broadcast) and a PUSCH. In some examples, the UE 215-b may support about a 20 MHz radio frequency bandwidth for one or more other channels, such as other uplink channels and other downlink channels. That is, eRedCap UEs may support about 20 MHz radio frequency bandwidth for baseband channels other than the PDSCH and the PUSCH.

In some examples, while eRedCap UEs and non-eRedCap UEs (e.g., RedCap UEs or eMBB UEs) may use multiple (e.g., different) preamble indices for a RACH procedure (e.g., a Msg1 based indication), the eRedCap UEs and the non-eRedCap UEs may share a same time-frequency location for transmission of a respective preamble. The time-frequency location used for transmission of a preamble may be referred to as a random access channel (RACH) occasion, a physical random access channel (PRACH) occasion, or a random access occasion. In some examples, the UE 215-a (e.g., a non-eRedCap UE) and the UE 215-b (e.g., an eRedCap UE) may each perform a random access procedure to establish a connection with the network entity 205. In some examples, such as for a contention based random access procedure, the UE 215-a and the UE 215-b may select a random access preamble (e.g., a preamble 230-a and a preamble 230-b, respectively) to transmit to the network entity 205. In some examples, the UE 215-a and the UE 215-b may include the respective preamble in random access request. The random access request may correspond to a first message (e.g., Msg1) of the random access procedure. For example, the UE 215-a and the UE 215-b may use a random access request to transmit the preamble 230-a and the preamble 230-b, respectively, to the network entity 205.

In the example of FIG. 2, the UE 215-a and the UE 215-b may use a same PRACH occasion to transmit the preamble 230-a and the preamble 230-b, respectively, to the network entity 205. In some examples, transmission of a random access preamble may be referred to as a PRACH transmission. In some examples, the network entity 205 may select the preamble 230-a or the preamble 230-b to establish a connection to the corresponding UE. That is, the network entity 205 may select the preamble 230-a to establish a connection with the UE 215-a or the preamble 230-b to establish a connection with the UE 215-b. Additionally, or alternatively, the network entity 205 may indicate the selected random access preamble to the UEs 215. For example, the network entity 205 may transmit a random access response that indicates the selected preamble to the UEs 215.

In response to receiving one or more random access requests, the network entity 205 may transmit a random access response, such as a random access response 265-a and a random access response 265-b. The random access response may include a random access response grant using a physical downlink control channel (PDCCH). That is, the random access response grant may include PDCCH signaling, such as downlink control information (DCI). In some examples, the random access response grant may be scheduled for UEs (e.g., all UEs) that share same PRACH occasion. For example, subsequent to a PRACH transmission during a PRACH occasion, the UE 215-a and the UE 215-b may monitor for a random access response (e.g., DCI) during a duration (e.g., a random access response window, such as may be configured using a rar-WindowLength information element (IE) in a system information block (SIB) message). In some examples, the UE 215-a may monitor the PDCCH during a window 235-a and the UE 215-b may monitor the PDCCH during a window 235-b. For example, the UE 215-a and the UE 215-b may monitor the PDCCH for a random access response grant in which CRC bits included in the grant may be scrambled with a random access RNTI (RA-RNTI) corresponding to the PRACH transmission (e.g., the PRACH occasion). In some examples, the UE 215-a and the UE 215-b may monitor the PDCCH for DCI of a format (e.g., a Format 1_0) with CRC bits scrambled using the RA-RNTI corresponding to the PRACH occasion. That is, in response to receiving the preamble 230-a or the preamble 230-b, or both the preamble 230-a and the preamble 230-b, the network entity 205 may transmit a random access response including a grant 240-a and another random access response including a grant 240-b using the PDCCH. The grant 240-a and the grant 240-b may be scrambled using an RA-RNTI associated with the PRACH occasion in which the preamble 230-a and the preamble 230-b were transmitted from the UE 215-a and the UE 215-b, respectively. In such an example, if the UE 215-a and the UE 215-b successfully detect (and decode) the grant 240-a and the grant 240-b, respectively, the UE 215-a and the UE 215-b may decode a corresponding PDSCH message carrying random access response data. For example, the random access response 265-a may include the grant 240-a and a payload 245-a (e.g., the PDSCH message carrying the random access response data, a transport block) corresponding to the grant 240-a. In such an example, if the UE 215-a successfully decodes the grant 240-a, the UE 215-a may determine to decode the payload 245-a. Additionally, or alternatively, if the UE 215-a successfully decodes the payload 245-a, the UE 215-a may proceed to transmit a third message (e.g., Msg3) of the random access procedure.

In some examples, such as for NR systems, the RA-RNTI may be determined (e.g., calculated) in accordance with the following Equation 1:

$$RA - RNTI = 1 + s\_id + 14 \times t\_id + 14 \times 80 \times f\_id + 14 \times 80 \times 8 \times ul\_carrier \_id \qquad ( 1 )$$

in which s_id may correspond to an index of a relatively first OFDM symbol of the PRACH occasion (e.g., 0≤s_id<14). Additionally, or alternatively, t_id may correspond to an index of a relatively first slot of the PRACH occasion in a system frame (e.g., 0≤t_id<80). In some examples, a subcarrier spacing to determine t_id may be based on a value of a parameter (μ), which may be configured at the network entity 205 and the UEs 215. In some examples, f_id may correspond to an index of the PRACH occasion in a frequency domain (0≤f_id<8) and ul_carrier_id may correspond to an uplink carrier used at the UE 215-a and the UE 215-b for the PRACH transmission (e.g., ul_carrier_id may correspond to a value of 0 for a normal uplink (NUL) carrier and 1 for a supplementary uplink (SUL) carrier). In such examples, the RA-RNTI may be determined (e.g., calculated) irrespective of a preamble identifier (ID) indicated using the random access response. That is, the RA-RNTI calculation may depend on time-frequency location of the PRACH resource (e.g., the PRACH resource used for the PRACH transmission, the PRACH occasion), but may not depend on a preamble ID of a PRACH sequence (e.g., a preamble indicated using the random access response). In some examples, a preamble ID may include a preamble index, such as may be indicated using an RRC parameter (e.g., an ra-PreambleIndex field of an IE transmitted using RRC signaling). In such examples, UEs that transmit a random access request (e.g., a PRACH, a preamble) at same time-frequency location (e.g., using a same PRACH occasion), may be able to decode a same random access response grant (e.g., an RA-RNTI grant). For example, due to the UE 215-a and the UE 215-b using a same PRACH occasion to transmit the preamble 230-a and the preamble 230-b, respectively, the UE 215-a and the UE 215-b may be able to decode a random access response grant that is scrambled using a same RA-RNTI (e.g., an RA-RNTI calculated based on the PRACH occasion). In some examples, the ability to decode a random access response grant may be based on whether the UEs have sufficient coverage to receive the random access response grant. That is, the UE 215-a and the UE 215-b may be able to decode random access response grants (e.g., one or more grants 240) if the UEs 215 have sufficient coverage to receive the random access response grants.

In some examples, if the UEs 215 fail to successfully receive a payload included in a random access response grant, the UEs 215 may be configured to retransmit a preamble. For example, if the UE 215-a and the UE 215-b receive and successfully decode the grant 240-a and the grant 240-b, the UE 215-a and the UE 215-b may attempt to decode the corresponding payload (e.g., the payload 245-a and the payload 245-b, respectively). In some examples, if the UE 215-a and the UE 215-b fail to decode the corresponding payload within the window 235-a and the window 235-b, respectively, the UE 215-a and the UE 215-b may determine to retransmit the preambles 230. For example, the UE 215-a may determine to retransmit the preamble 230-a and the UE 215-b may determine to retransmit the preamble 230-b. That is, if a UE fails to successfully receive (and decode) a payload (e.g., a transport block in a corresponding PDSCH) within a random access response window, one or more relatively higher layers (e.g., of a protocol stack associated with the UE) may indicate to a physical layer (e.g., of the protocol stack associated with the UE) to transmit (or retransmit) a PRACH. In some examples, if requested by the relatively higher layers, the UE may transmit (or retransmit) a PRACH during some duration (e.g., no later than about N_{T,1}+0.75 ms, in which N_{T,1} may correspond to a time duration of symbols corresponding to a PDSCH processing time for the UE) subsequent to a relatively last symbol of the window, or a relatively last symbol of the PDSCH reception. That is, the UE may retransmit the PRACH prior to an end of the window if the UE detects a random access grant (e.g., a DCI scrambled via an RA-RNTI) but fails to decode the corresponding payload (e.g., the random access response payload, the PDSCH message carrying the random access response data).

Additionally, or alternatively, a UE may be configured to retransmit a preamble (e.g., a PRACH), if a random access response payload (e.g., the PDSCH message carrying the random access response data, the transport block) fails to include an ID corresponding to the preamble transmitted from the UE (e.g., a preamble ID selected at the UE). For example, the UE 215-b may determine that the payload 245-b fails to include an ID corresponding to the preamble 230-b. In some examples, however, a bandwidth 260-a used at the network entity 205 to transmit the payload 245-b may exceed a bandwidth 260-b supported at the UE 215-b. For example, the network entity 205 may transmit the payload 245-b, which may include an ID corresponding to the preamble 230-b, using the bandwidth 260-a (e.g., a bandwidth of about 20 MHz) and the UE 215-b (e.g., an eRedCap UE) may support a bandwidth 260-b (e.g., a bandwidth of about 5 MHz). For example, a bandwidth of a shared channel 255 capable of being monitored at the UE 215-b may correspond to a bandwidth 260-b. In such an example, the UE 215-b may be incapable of successfully decoding the payload 245-b and may determine to retransmit the preamble 230-b irrespective of the payload 245-b including the ID corresponding to the preamble 230-b. Additionally, or alternatively, the UE 215-a (e.g., a non-eRedCap UE, such as an eMBB UE or a RedCap UE) may support a bandwidth of about 20 MHz. As such, the UE 215-a may successfully decode a payload transmitted from the network entity using the bandwidth 260-a. That is, the UE 215-a may support the bandwidth 260-a and the UE 215-b may support the bandwidth 260-b. In such examples, the network entity 205 may be incapable of transmitting random access responses using bandwidths supported at the UE 215-a and the UE 215-b. For example, the network entity 205 may be incapable of determining how to send a random access response to two sets of UEs that may support multiple (e.g., different) baseband bandwidths. Although the example of FIG. 2 illustrates the grant 240-b and the payload 245-b spanning the bandwidth 260-a, it is to be understood that the grant 240-b and the payload 245-b may span multiple different bandwidths, including the bandwidth 260-b.

In some examples, if both eRedCap UEs and non-eRedCap UEs (e.g., RedCap UEs or eMBB UEs) transmit a PRACH using same PRACH occasion, the eRedCap UEs and the non-eRedCap UEs may both be able to decode the corresponding random access response grant (e.g., if the eRedCap and non-eRedCap UEs have sufficient coverage). For example, the UE 215-a and the UE 215-b may be capable of decoding the grant 240-a and the grant 240-b, respectively, due to the preamble 230-a and the preamble 230-b being transmitted using a same PRACH occasion. In such an example, the non-eRedCap UEs may be capable of decoding corresponding random access response payload. However, due to a constrained shared channel bandwidth (e.g., due to eRedCap UEs supporting a PDSCH bandwidth of about 5 MHz), some eRedCap UEs may be incapable of decoding the corresponding random access response payload. For example, a set of eRedCap UEs that have relatively good coverage may be incapable of decoding the random access response payload. In some examples, if eRedCap UEs fail to decode the random access response payload, the eRedCap UEs may retransmit the PRACH, irrespective of the random access response payload including an ID corresponding to a preamble selected at the UEs. For example, the UE 215-a may be capable of decoding the payload 245-a, but the UE 215-b may be incapable of decoding the payload 245-b. In such an example, the UE 215-b may retransmit the preamble 230-b irrespective of whether the payload 245-b includes an ID corresponding the preamble 230-b, which may lead to increased random access (e.g., RACH) latency within the wireless communications system 200.

In some examples, the UE 215-b may be capable of indicating, to the network entity 205, that the UE 215-b supports reduced capabilities (e.g., that the UE 215-b may be an eRedCap UE). For example, the UE 215-b and the network entity 205 may support one or more mechanisms for relatively early indication, from the UE 215-b, that the UE 215-b may be an eRedCap UE or one or more other UE types that may have reduced capabilities. In some examples, a relatively early indication of eRedCap UEs (e.g., operating within the wireless communications system 200) may be enabled through one or more schemes. For example, the UE 215-b may use a message transmitted as part of a random access procedure (e.g., Msg1) to indicate that the UE 215-b may be an eRedCap UE. That is, the UE 215-b may support a Msg1-based early indication scheme. In some examples, the UE 215-b may use an initial bandwidth part to transmit the message (e.g., the Msg1). In such an example, in response to receiving the message from the UE 215-b, the network entity 205 may assign another initial bandwidth part (e.g., a separate initial bandwidth part) for the UE 215-b. For example, a quantity of PRACH occasions capable of being included in an initial bandwidth part may be constrained and, as such, using different PRACH occasions for multiple (e.g., different) UE types might be relatively costly. Thus, in some examples, the network entity 205 may assign different initial bandwidth parts to non-eRedCap UEs (e.g., the UE 215-a) and eRedCap UEs (e.g., the UE 215-b). In some other examples, a quantity of PRACH occasions capable of being included in an initial bandwidth part may be suitable for multiple types of UEs. In such examples, the network entity 205 may assign an initial bandwidth part that may be shared between the non-eRedCap UEs (e.g., the UE 215-a) and eRedCap UEs (e.g., the UE 215-b). For example, in response to receiving an indication that the UE 215-b may be an eRedCap UE, the network entity 205 may assign an initial bandwidth part to the UE 215-b that may be shared with the UE 215-a. In some examples, the network entity 205 may assign multiple (e.g., separate) time-frequency locations for PRACH resources used at the UE 215-a and the UE 215-b. In some other examples, the network entity 205 may assign a same time-frequency location for a PRACH resource to be used at the UE 215-a and the UE 215-b. In such examples, the network entity 205 may configure the UE 215-a and the UE 215-b with multiple (e.g., different) set of preamble indices. Additionally, or alternatively, the UE 215-b may use another message transmitted as part of a random access procedure (e.g., Msg3) to indicate that the UE 215-b may be an eRedCap UE. For example, the UE 215-b may support a Msg3-based early indication scheme.

In some examples, the wireless communications system 200 may support one or more random access response schemes for UEs with constrained bandwidths, such as eRedCap UEs. For example, the network entity 205 may use a random access response grant to indicate a UE type associated with the random access response grant and the corresponding payload. As illustrated in the example of FIG. 2, the UE 215-a and the UE 215-b may receive one or multiple random access responses (e.g., each including a respective grant 240 and a respective payload 245) from the network entity 205 during a random access window that may be associated with a random access request. For example, the UE 215-a and the UE 215-b may receive one or multiple random access responses from the network entity 205 during the windows 235-a and the window 235-b, respectively, that may be associated with the preambles 230-a and the preamble 230-b. In response to receiving a random access response from the network entity 205, the UE 215-a or and the UE 215-b may determine that the random access response is associated with a UE type and may decode a transport block of the random access response (e.g., the payload 245) based on the indicated UE type. For example, the network entity 205 may include a UE type indication 250 in a grant 240-b. The UE type indication 250 may indicate, to the UE 215-b, that the grant 240-b and the corresponding payload (e.g., the payload 245-b) may be associated with eRedCap UEs. For example, the UE type indication 250 may indicate that the payload 245-b may be transmitted using a reduced bandwidth, such as bandwidth that may be supported at the UE 215-b (or one or more other eRedCap UEs). In such an example, the UE 215-b may determine to decode the payload 245-b based on the UE type indication 250 indicating a UE type corresponding to the UE 215-b.

In some examples, the network entity 205 may use one or more fields in reserved bits of a random access response grant to indicate the UE type. For example, the network entity 205 may be capable of indicating whether the random access response grant (e.g., including the UE type indication) may be applicable for eRedCap UEs using these fields. That is, the network entity 205 may use a field included in the random access response grant to indicate whether the random access response grant may be intended for eRedCap UEs or one or more other UE types. As illustrated in the example of FIG. 2, the network entity 205 may use one or more reserved bits included in the grant 240-b (e.g., DCI) to signal the UE type indication 250 to the UE 215-b. In some examples, in response to receiving the UE type indication 250, the UE 215-b (e.g., an eRedCap UE) may attempt to decode a random access response payload corresponding to the random access response grant. For example, the network entity 205 may use reserved bits included in the grant 240-b to indicate that the payload 245-b is intended for eRedCap UEs (e.g., is transmitted using a bandwidth suitable for eRedCap UEs). In such an example, the UE 215-b may attempt to decode the payload 245-b in response to determining (e.g., based on decoding the grant 240-b) that the payload 245-b is intended for eRedCap UEs. In some other examples, the UE 215-b may determine (e.g., based on decoding the grant 240-b) that the payload 245-b may be intended for another UE type. In such examples, the UE 215-b may refrain from decoding (e.g., reading) the payload 245-b and monitor the PDSCH (e.g., continue to monitor the PDSCH, wait) within the window 235-b for one or more other random access response grants. That is, in such examples, an eRedCap UE may wait to receive another random access response grant that may be intended for the eRedCap UE within a random access response window. For example, the UE 215-b may monitor for (and receive) a grant 240-c. In such an example, the grant 240-c may include one or more reserved bits that indicate that the payload 245-c is intended for eRedCap UEs. In such an example, the UE 215-b may attempt to decode (e.g., read) the payload 245-c.

In some examples, to indicate a UE type to eRedCap UEs, the network entity 205 may send one or multiple random access response grants. For example, the network entity 205 may send a random access response grant twice or more than twice. In such an example, a first random access response grant may be intended for non-eRedCap UEs (e.g., RedCap UEs or eMBB UEs), such as the UE 215-a, and a second random access response grant may be intended for eRedCap UEs, such as the UE 215-b. For example, the network entity may transmit the grant 240-a and a grant 240-b, which may be intended for the UE 215-a and the UE 215-b, respectively. In such an example, the grant 240-b may include the UE type indication 250.

For example, the grant 240-b may be an example of a downlink control channel message that includes UE type information indicative of one or more UE types with which the downlink control channel message (e.g., the grant 240-b) may be associated. That is, the network entity 205 may use the UE type indication 250 to indicate one or more UE types, such as eRedCap UEs or one or more other UE types, such as one or more future UE types. In some examples, the grant 240-b may include one or more bits (e.g., in a field) that indicate one or more UE types for which the grant 240-b is associated. That is, the UE type information (e.g., the UE type indication 250) may be included in one or more bits in a field included in the grant 240-b and each bit of the one or more bits or multiple bits of the one or more bits may correspond to a respective UE type. Additionally, or alternatively, each bit of the one or more bits or multiple bits of the one or more bits may correspond to a respective group of UE types. In some examples, the network entity 205 may use multiple reserved bits included in the grant 240-b (e.g., a random access response grant, a downlink control channel message) to indicate whether the corresponding random access response payload is intended for one or multiple UE types. In some examples, a same bit may be reserved for multiple different UE types. Additionally, or alternatively, the network entity 205 may configure the UEs 215 with mapping information associated with the reserved bits to indicate different UE types that may be configured via the network entity 205. That is, the mapping information may be used at the UEs 215 to map each bit (or multiple bits) included in the field to the respective UE type. Additionally, or alternatively, the mapping information may be used at the UEs 215 to map each bit (or multiple bits) included in the field to the respective group of UE types. In some examples, the network entity 205 may transmit information associated with the mapping through system information or a handover command.

In some examples, a UE may receive a random access response grant unintended for the UE prior to receiving a random access response grant intended for the UE. For example, the network entity may transmit a first random access response grant for non-eRedCap UEs (e.g., RedCap or eMBB UEs) and a second random access response grant for eRedCap UEs. In such an example, if an eRedCap UE receives the first random access response grant (e.g., prior to the second random access response grant), the eRedCap UE may refrain from decoding a payload corresponding to the first random access response grant. For example, based on decoding the first random access response grant, the eRedCap UE may determine that the first random access response grant includes a UE type indication that indicates a UE type other than eRedCap UEs (or fails to include a UE type indication). Additionally, or alternatively, if a non-eRedCap UE receives the second random access response grant prior to the first random access response grant, the non-eRedCap UE may attempt to decode the corresponding payload. For example, the non-eRedCap UE may be incapable of decoding the bits included in the second random access response grant that indicate that the corresponding payload is intended for eRedCap UEs.

As illustrated in the example of FIG. 2, the UE 215-a may fail to receive (or fail to successfully decode, such as due to link coverage) a grant that may be intended for non-eRedCap UEs. Additionally, or alternatively, the UE 215-a may receive a grant intended for eRedCap UEs prior to receiving a grant intended for a non-eRedCap (e.g., a RedCap or eMBB) UEs. For example, the UE 215-a may receive the grant 240-a prior to receiving a grant 240-d (e.g., associated with a payload 245-d). In such an example, the grant 240-a may be intended for eRedCap UEs and the grant 240-d may be intended for non-eRedCap UEs. That is, the grant 240-a may include one or more reserved bits that indicate that the corresponding payload (e.g., the payload 245-a) is intended for eRedCap UEs (or another UE type different from a RedCap UE or an eMBB UE). In such an example, the UE 215-a may be incapable of decoding the one or more reserved bits and may therefore be unaware that the payload 245-a is intended for eRedCap UEs. Accordingly, the UE 215-a may attempt to decode the payload 245-a. In some examples, based on decoding the payload 245-a, the UE 215-a may determine that the payload 245-a fails to include an identifier associated with the preamble 230-a and may determine to re-transmit the preamble 230-a (e.g., unnecessarily) prior to receiving the grant 240-d (e.g., the grant intended for non-eRedCap UEs).

In some examples, to avoid a case in which the non-eRedCap UE (e.g., a RedCap UE or an eMBB UE) may read a random access response grant (or the corresponding payload) intended for eRedCap UEs, the network entity 205 may include an indication for the eRedCap UE and the non-eRedCap UE. For example, the network entity 205 may use one or more fields of multiple fields included in the random access response grant to indicate that the random access response grant is intended for eRedCap UEs and that the non-eRedCap UE is to refrain from decoding the corresponding payload. In some examples, the network entity 205 may use an MCS field, a transport block scaling field, or both. For example, the network entity 205 may use a first MCS level field (e.g., a field decodable at the non-eRedCap UE) to indicate that the corresponding payload is intended for eRedCap UEs and that non-eRedCap UEs may refrain from decoding the corresponding payload. In some examples, to indicate for the non-eRedCap UE to refrain from decoding the corresponding payload, the first MCS level field may indicate “Reserved.” For example, the non-eRedCap UE may determine that an MCS for the corresponding payload (e.g., a transport block) is reserved based on the first MCS level field included in the random access response grant indicating “Reserved.” In such examples, the non-eRedCap UE may determine that the random access response grant is invalid and may refrain from decoding (e.g., may ignore) the corresponding payload. Additionally, or alternatively, the network entity 205 may use a second MCS level field included in the grant intended for the eRedCap UEs to indicate an MCS level to be used at the eRedCap UEs to decode the corresponding payload. In some examples, the network entity 205 may use reserved bits included in the random access response grant (e.g., a PDCCH message, such as DCI) to include the second MCS level field (e.g., for the eRedCap UEs).

In the example of FIG. 2, a first MCS level field included in the grant 240-a may indicate that the random access response including the grant 240-a and the payload 245-a is associated with eRedCap UEs. Additionally, or alternatively, a second MCS level field included in the grant 240-a may indicate an MCS level for the payload 245-a. In such an example, the UE 215-a may refrain from decoding the payload 245-a (e.g., may determine that the grant 240-a is invalid). Additionally, or alternatively, a first MCS level field included in the grant 240-b may indicate that the random access response including the grant 240-b and the payload 245-b is associated with eRedCap UEs. Additionally, or alternatively, a second MCS level field included in the grant 240-b may indicate an MCS level for the payload 245-b. In such an example, the UE 215-b may decode the payload 245-b using the indicated MCS level. In some examples, the first MCS level field may correspond to the UE type indication 250.

Additionally, or alternatively, the network entity 205 may use a first transport block scaling field (e.g., a field decodable at the non-eRedCap UE) to indicate that the corresponding payload is intended for eRedCap UEs and that the non-eRedCap UE may refrain from decoding the corresponding payload. In some examples, to indicate for the non-eRedCap UE to refrain from decoding the corresponding payload, one or more bits associated with the second transport block scaling field may be set to a value, such as “11.” For example, the non-eRedCap UE may determine that an MCS for the corresponding payload (e.g., a transport block) is reserved based on the second transport block scaling field included in the random access response grant indicating “11,” which may correspond to reserved. In such examples, the non-eRedCap UE may determine that the transport block scaling field is invalid and may refrain from decoding (e.g., may ignore) the corresponding payload. Additionally, or alternatively, the network entity 205 may use a second transport block scaling field included in the grant intended for eRedCap UEs to indicate, to the eRedCap UE, a transport block scaling for the corresponding payload. In some examples, the network entity 205 may use reserved bits included in the random access response grant (e.g., a PDCCH, such as DCI) to include the second transport block scaling field (e.g., for the eRedCap UE).

As illustrated in the example of FIG. 2, a first transport block scaling field included in the grant 240-a may indicate that the random access response including the grant 240-a and the payload 245-a is associated with eRedCap UEs (e.g., that the transport block scaling for the payload 245-a is reserved). In such an example, the UE 215-a may refrain from decoding the payload 245-a (e.g., may determine that the grant 240-a is invalid). Additionally, or alternatively, a first transport block scaling field included in the grant 240-b may indicate that the random access response including the grant 240-b and the payload 245-b is associated with eRedCap UEs. Additionally, or alternatively, a second transport block scaling field included in the grant 240-b may indicate a transport block scaling for the payload 245-b. In such an example, the UE 215-b may decode the payload 245-b using the indicated transport block scaling. In some examples, the first transport block scaling field may correspond to the UE type indication 250.

In some other examples, the network entity 205 may indicate a UE type associated with a random access response grant using an RA-RNTI. For example, an RA-RNTI calculation may incorporate a UE type. In some examples, incorporating a UE type into an RA-RNTI calculation may enable the network entity 205 to transmit multiple (e.g., different) random access responses among different UE types (e.g., relatively smoothly). In some examples, the network entity 205 (e.g., and the UEs 215) may determine (e.g., calculate) the RA-RNTI using one or more parameters. For example, the RA-RNTI may be determined in accordance with (e.g., may take the form of) the following Equation 2:

$$RA - RNTI\_new = 1 + s\_id + 14 \times t\_id + 14 \times 80 \times f\_id + 14 \times 80 \times 8 \times ul\_carrier \_id + 14 \times 80 \times 8 \times 2 \times UE\_type \qquad ( 2 )$$

in which the parameter UE_type may correspond to a value of 0 for non-RedCap UEs (e.g., eMBB UEs, RedCap UEs, or one or more other UE types). Additionally, or alternatively, the parameter UE_type may correspond to a value of 1 for eRedCap UEs. In some examples, the parameter UE_type may correspond to another value (e.g., a value other than 0 or 1) for another UE type. That is, multiple values may be used to indicate multiple (e.g., different) UE types. As illustrated in the example of FIG. 2, the network entity 205 may use an RA-RNTI determined with the parameter UE_type set to a value of 1 to scramble CRC bits included in the grant 240-b. In such an example, the UE 215-b may determine that the grant 240-b includes CRC bits that are scrambled by an RA-RNTI that is associated with eRedCap UEs. For example, the UE 215-b may determine (e.g., calculate) a CRC value for the grant 240-b based on a UE_type parameter (e.g., an index value, an identifier) representative of eRedCap UEs (e.g., with a value of 1). In such an example, the UE 215-b may determine to decode the payload 245-b.

In some other examples, the wireless communications system 200 may support a random access response scheme in which the network entity 205 may configure multiple (e.g., different) time-frequency resources among multiple (e.g., different) UE types. For example, the network entity 205 may configure multiple (e.g., different) PRACH occasions among eRedCap UEs (e.g., the UE 215-b) and non-eRedCap UEs (e.g., the UE 215-a). In such an example, an RA-RNTI for eRedCap UEs and non-eRedCap UEs may be (e.g., remain) different, for example based on one or more calculations (e.g., in accordance with Equation 1). Additionally, or alternatively, in such examples, the network entity 205 may refrain from sending a random access response (e.g., data associated with the random access response) for eRedCap UEs and non-eRedCap UEs in a same payload (e.g., a random access response PDSCH payload). In some examples, a quantity of PRACH occasions capable of being included in each initial bandwidth part may be constrained and, as such, using different PRACH occasions for multiple (e.g., different) UE types might be relatively costly.

In some examples, the network entity 205 may configure different initial bandwidth parts for eRedCap and non-eRedCap UEs. As illustrated in the example of FIG. 2, the UE 215-b may receive a control message 270 from the network entity 205 that may indicate one or more initial bandwidth parts to be used for a random access procedure with the network entity 205. In such an example, each of the one or more initial bandwidth parts may be associated with a type (e.g., different types) of UE. In some examples, the UE 215-b may determine to use an initial bandwidth part associated with eRedCap UEs for a random access procedure with the network entity 205 (e.g., to transmit the preamble 230-b or one or more other messages). Additionally, or alternatively, the UE 215-b may determine that none of the initial bandwidth parts included in the control message 270 are associated with eRedCap UEs. In such an example, the UE 215-b (e.g., an eRedCap UE) may select one or more of the initial bandwidth parts included in the control message 270 to use for the random access procedure with the network entity 205. For example, the UE 215-b may select a single initial bandwidth part or multiple initial bandwidth parts. In such an example, the UE 215-b may transmit a random access request (e.g., the preamble 230-b) to the network entity 205 via the selected initial bandwidth part. That is, the UE 215-b may transmit the random access request (e.g., the preamble 230-b) to the network entity 205 using a single selected initial bandwidth part or multiple selected bandwidth parts.

In some examples, the UE 215-b may select an initial bandwidth part included in the control message 270 based on one or more rules. For example, the UE 215-b may receive an indication from the network entity 205 of one or more rules for initial bandwidth part selection. The UE 215-b may receive the indication from the network entity 205 if none of the initial bandwidth parts included in the control message 270 are associated with eRedCap UEs. Additionally, or alternatively, the UE 215-b may be otherwise configured (e.g., preconfigured) with one or more rules for initial bandwidth part selection. In some examples, the one or more rules may include conditional expressions, such as if/then statement, or other logical expressions or statements, among other examples of rules that may be used for a selection. For example, a rule may define a selection hierarchy. That is, the UE 215-b may select an initial bandwidth part among the one or more initial bandwidth parts in accordance with a selection hierarchy. In some examples, the hierarchy may prioritize initial bandwidth parts based on a likeness between eRedCap UEs and other UE types that may be associated with the configured initial bandwidth parts. For example, the hierarchy may prioritize an initial bandwidth part associated with RedCap UEs over other initial bandwidth parts that may be associated with eMBB UEs. In such an example, if an initial bandwidth part (e.g., a separate initial bandwidth part) for eRedCap UEs is not configured, the UE 215-b may select a bandwidth part configured for RedCap UEs. That is, if a RedCap initial bandwidth part is configured (e.g., using the control message 270), the UE 215-b (e.g., an eRedCap UE) may use the RedCap initial bandwidth part as the initial bandwidth part for eRedCap UEs. In some examples, a RedCap initial bandwidth part may not be configured. In such examples, the UE 215-b may select an initial bandwidth part associated with another UE type or the UE 215-b may select a default initial bandwidth part (e.g., an NR bandwidth part). For example, if a RedCap initial bandwidth part is not configured, the UE 215-b may use a default initial bandwidth part as the initial bandwidth part for eRedCap UEs. In some examples, selecting an initial bandwidth part in accordance with one or more rules may enable increased flexibility (e.g., and increased resource usage) at the network entity 205, among other possible benefits.

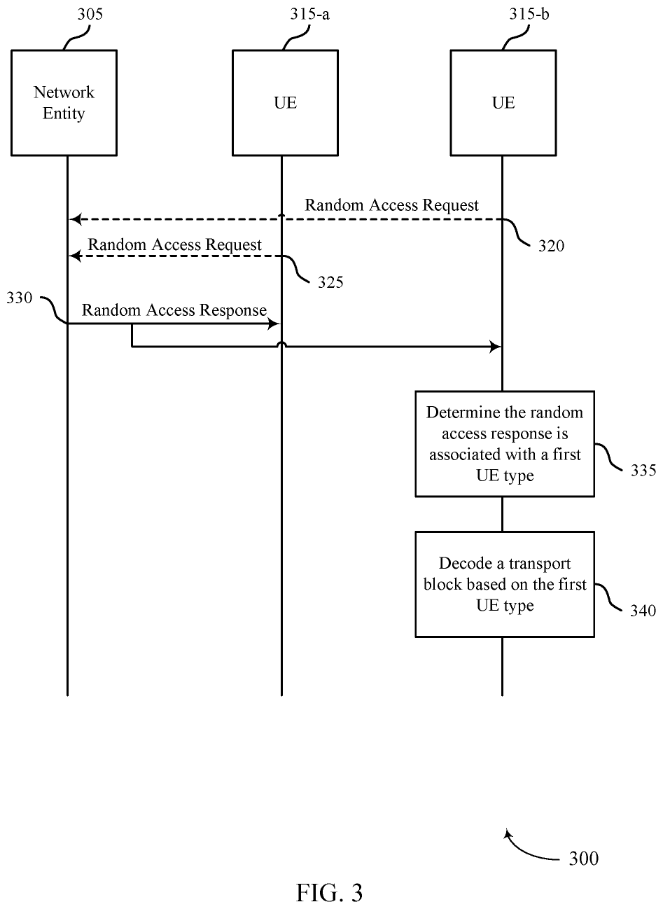

FIG. 3 illustrates an example of a process flow 300 that supports random access response schemes for eRedCap UEs in accordance with one or more aspects of the present disclosure. In some examples, the process flow 300 may implement one or more aspects of wireless communications system 100 and the wireless communications system 200. For example, the process flow 300 may include example operations associated a network entity 305, a UE 315-a, and a UE 315-b, which may be examples of the corresponding devices described with reference to FIGS. 1 and 2. The operations performed by the network entity 305 and the UEs 315 may support improvements to communications between the UEs 315 and the network entity 305, among other benefits. In the following description of the process flow 300, the operations between the UEs 315 and the network entity 305 may occur in a different order than the example order shown. Additionally, or alternatively, the operations performed by the UEs 315 and the network entity 305 may be performed in different orders or at different times. Some operations may also be omitted.

In some examples, multiple UE types may use a same set of time-frequency resources (e.g., a same random access occasion) to transmit a random access request to a network entity as part of a random access procedure for establishing a connection with the network entity. For example, at 320, the UE 315-b may transmit a random access request (e.g., including a random access preamble) to the network entity 305 using a random access occasion. In such an example, at 325, the UE 315-a may transmit another random access request to the network entity 305 using the same random access occasion. In response, the network entity 305 may transmit a random access response to the UE 315-a and the UE 315-b. In the example of FIG. 3, the UE 315-a may be an example of a non-eRedCap UE, such as a RedCap UE or an eMBB UE. Additionally, or alternatively, the UE 315-b may be an example of an eRedCap UE. That is, the UE 315-b may be associated with an eRedCap UE type, which may correspond to reduced capabilities with respect to a RedCap UE type and an eMBB UE type (e.g., a UE type associated with the UE 315-a).

At 330, the network entity 305 may transmit the random access response to the UE 315-a and the UE 315-b during a random access window associated with the random access requests (e.g., transmitted at 320 and 325). The random access response may be an example of a random access response as described throughout the present disclosure, including with reference to FIG. 2. For example, the random access response may include a downlink control channel message (e.g., a grant) that includes UE type information indicative of one or more UE types with which the downlink control channel message may be associated. For example, the downlink control channel message may include one or more bits (e.g., in a field) that indicate one or more UE types for which the downlink control channel message is associated. That is, the UE type information may be included in one or more bits in a field included in the downlink control channel message. In some examples, the one or more bits may indicate that the random access response is associated with a first UE type, such as eRedCap UEs. That is, the one or more UE types may include the first UE type. Additionally, or alternatively, the first UE type may be associated with a first bandwidth processing capability (e.g., a first maximum processing capability or otherwise suitable processing capability) that may be reduced relative to (e.g., lower than) a second bandwidth processing capability (e.g., a second maximum processing capability or otherwise suitable processing capability) associated with eMBB UEs. In some examples, first bandwidth processing capability may pertain to one or more combinations of radio frequency bandwidth, baseband bandwidth, or bandwidth for PDSCH or PUSCH.

In some examples, the UE type information may include respective UE type information for each respective UE type of the one or more UE types. In such examples, the UE 315-b, may receive mapping information that maps each respective UE type information of the UE type information to a respective UE type of the one or more UE types. Additionally, or alternatively, one or more of the respective UE type information of the UE type information may correspond to a group of different UE types.

At 335, in response to receiving the random access response from the network entity 305, the UE 315-b may determine that the random access response is associated with the first UE type. For example, the UE 315-b may determine that the random access response is associated with the first UE type based on the mapping information. In some examples, the mapping information may include a mapping between the one or more UE types and different sets of one or more bits included in the field of the random access response. That is, the mapping may be an example of a mapping as described throughout the present disclosure, including with reference to FIG. 2. For example, the mapping may include a set of the one or more bits in the field that is representative of a group of different UE types. In some examples, the UE 315-b may receive the mapping information from the network entity 305, such as in a system information message or a handover command.

Additionally, or alternatively, the UE 315-b may determine that the random access response is associated with the first UE type based on an RNTI, such as an RA-RNTI, used to scramble CRC bits included in the random access response. For example, the UE 315-b may determine that the random access response includes a CRC value that is scrambled by an RA-RNTI that is associated with the first UE type. In such an example, the UE 315-b may calculate the RA-RNTI value based on an index representative of the first UE type, in accordance with Equation 2. That is, the RA-RNTI may be based on an index value associated with the first UE type. In some examples, the index may be one or multiple indices representative of multiple (e.g., different) UE types. For example, the index value may be one of multiple index values indicated to (or otherwise configured at) the UE 315-b. In such an example, each respective index value may be associated with a respective UE type (e.g., of the multiple UE types including the first UE type).

At 340, the UE 315-b may decode a transport block of the random access response based on the first UE type. For example, the UE 315-b may decode the transport block based on a determination that the UE 315-b is the first UE type (or of another UE type) and based on the random access response being associated with the first UE type. That is, the UE 315-b may decode the transport block based on the UE 315-b being an eRedCap UE and the random access response being associated with eRedCap UEs.

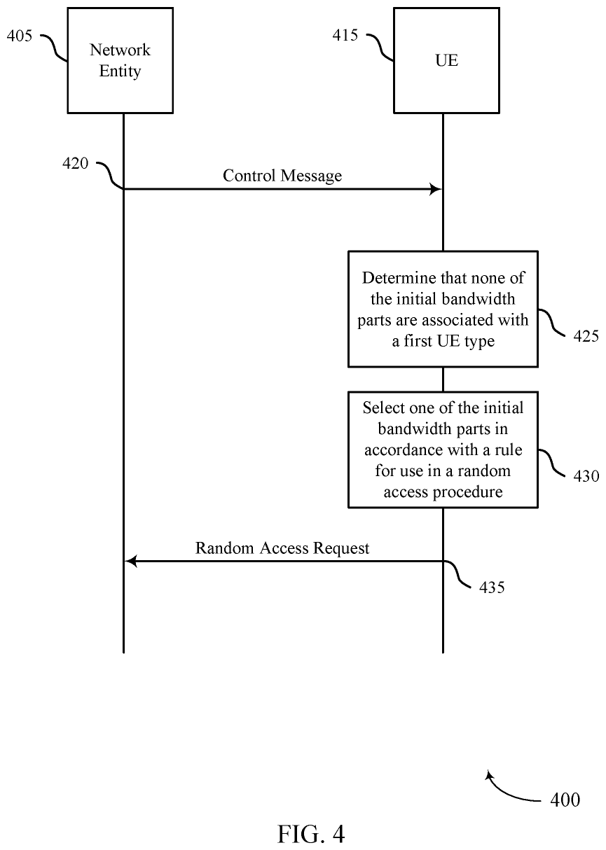

FIG. 4 illustrates an example of a process flow 400 that supports random access response schemes for eRedCap UEs in accordance with one or more aspects of the present disclosure. In some examples, the process flow 400 may implement one or more aspects of wireless communications system 100, the wireless communications system 200, and the process flow 300. For example, the process flow 400 may include example operations associated a network entity 405 and a UE 415, which may be examples of the corresponding devices described with reference to FIGS. 1 through 3. The operations performed by the network entity 405 and the UE 415 may support improvements to communications between the UE 415 and the network entity 405, among other benefits. In the following description of the process flow 400, the operations between the UE 415 and the network entity 405 may occur in a different order than the example order shown. Additionally, or alternatively, the operations performed by the UE 415 and the network entity 405 may be performed in different orders or at different times. Some operations may also be omitted. In some other examples, the network entity 405 may configure the UE 415 with multiple (e.g., different) time-frequency resources that may be associated with multiple (e.g., different) UE types.

At 420, the UE 415 may receive a control message from the network entity 405. The control message may be an example of a control message as described throughout the present disclosure, including with reference to FIG. 2. For example, the control message may indicate one or more initial bandwidth parts to be used for random access of the network entity 405. In some examples, each of the one or more initial bandwidth parts may be associated with a respective one or more UE types. For example, the one or more initial bandwidth parts may be associated with multiple (e.g., different) UE types.

At 425, the UE 415 may determine that none of the initial bandwidth parts included in the control message received at 420 are associated with a first UE type. In the example of FIG. 4, the first UE type corresponds to an eRedCap UE type. For example, the UE 415 may determine that none of the initial bandwidth parts are associated with eRedCap UEs. That is, the UE 415 may determine that eRedCap UEs are unassociated with the initial bandwidth parts included in (or indicated by) the control message.

At 430, the UE 415 may select one of the initial bandwidth parts (e.g., a particular initial bandwidth part, a single initial bandwidth part) for use in a random access procedure with the network entity 405. In some examples, the UE 415 may select the particular initial bandwidth part from the one or more initial bandwidth parts included in the control message in accordance with a rule for initial bandwidth part selection. For example, the UE 415 may select the particular initial bandwidth part according to a rule for bandwidth part selection, for example if none of the one or more initial bandwidth parts included in the control message are associated with the first UE type (e.g., eRedCap UEs). The rule may be an example of one or more rules as described throughout the present disclosure, including with reference to FIG. 2. For example, the rule may indicate for the UE 415 to select the particular initial bandwidth part among the one or more initial bandwidth parts in accordance with a hierarchy. That is, the rule may define a selection hierarchy. In some examples, the selection hierarchy may prioritize (e.g., rank) initial bandwidth parts associated with RedCap UEs over initial bandwidth parts associated with other UE types, such as eMBB UEs. In some examples, the UE 415 may select multiple initial bandwidth parts.

At 435, the UE 415 may transmit a random access request to the network entity 405 via the selected initial bandwidth part (or via multiple selected initial bandwidth parts) included in the control message. The random access request many be an example of a random access request as described throughout the present disclosure, including with reference to FIG. 2. For example, the random access request may be transmitted from the UE 415 as part of a random access procedure with the network entity 405.

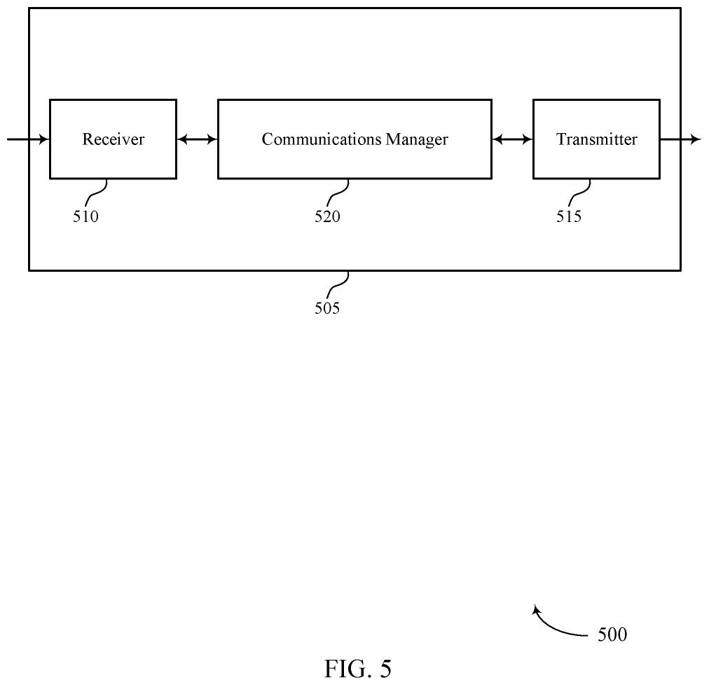

FIG. 5 shows a block diagram 500 of a device 505 that supports random access response schemes for eRedCap UEs in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to random access response schemes for eRedCap UEs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to random access response schemes for eRedCap UEs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of random access response schemes for eRedCap UEs as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first network node (e.g., the device 505) in accordance with examples as disclosed herein. For example, the communications manager 520 may be configured as or otherwise support a means for receiving a random access response from a second network node during a random access window associated with a random access request by the first network node. The communications manager 520 may be configured as or otherwise support a means for determining that the random access response is associated with a first UE type. The communications manager 520 may be configured as or otherwise support a means for decoding a transport block of the random access response based on the determination and the first network node being the first UE type.

Additionally, or alternatively, the communications manager 520 may support wireless communication at a first network node (e.g., the device 505) in accordance with examples as disclosed herein. For example, the communications manager 520 may be configured as or otherwise support a means for receiving a control message indicating one or more PRACH resources to be used for random access of a second network node, each of the one or more PRACH resources being associated with a respective one or more UE types. The communications manager 520 may be configured as or otherwise support a means for determining that none of the one or more PRACH resources included in the control message are associated with a first UE type, where the first network node is of the first UE type, and where the first UE type is an eRedCap UE type. The communications manager 520 may be configured as or otherwise support a means for selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources. The communications manager 520 may be configured as or otherwise support a means for transmitting the random access preamble to the second network node via the selected PRACH resource of the one or more PRACH resources.

Additionally, or alternatively, the communications manager 520 may support wireless communication at a first network node (e.g., the device 505) in accordance with examples as disclosed herein. For example, the communications manager 520 may be configured as or otherwise support a means for receiving a control message indicating one or more initial bandwidth parts to be used for random access of a second network node, each of the one or more initial bandwidth parts being associated with a respective one or more UE types. The communications manager 520 may be configured as or otherwise support a means for determining that none of the one or more initial bandwidth parts included in the control message are associated with a first UE type, where the first network node is of the first UE type, and where the first UE type is an eRedCap UE type. The communications manager 520 may be configured as or otherwise support a means for selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts. The communications manager 520 may be configured as or otherwise support a means for transmitting a random access request to the second network node via the selected initial bandwidth part of the one or more initial bandwidth parts.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

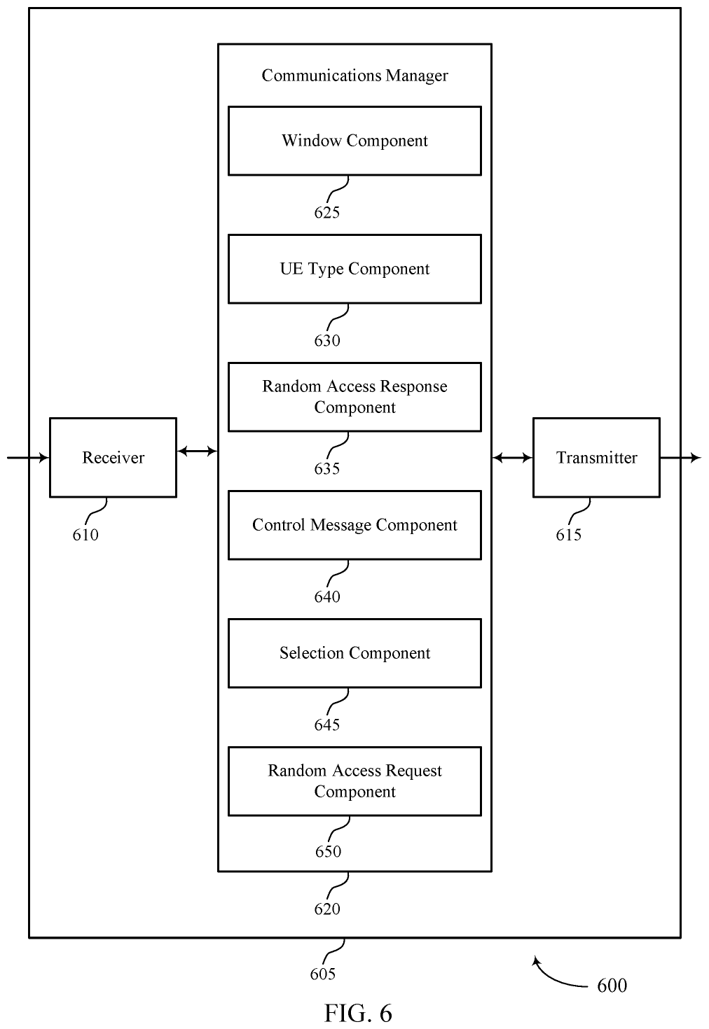

FIG. 6 shows a block diagram 600 of a device 605 that supports random access response schemes for eRedCap UEs in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to random access response schemes for eRedCap UEs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to random access response schemes for eRedCap UEs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of random access response schemes for eRedCap UEs as described herein. For example, the communications manager 620 may include a window component 625, a UE type component 630, a random access response component 635, a control message component 640, a selection component 645, a random access request component 650, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first network node (e.g., the device 605) in accordance with examples as disclosed herein. The window component 625 may be configured as or otherwise support a means for receiving a random access response from a second network node during a random access window associated with a random access request by the first network node. The UE type component 630 may be configured as or otherwise support a means for determining that the random access response is associated with a first UE type. The random access response component 635 may be configured as or otherwise support a means for decoding a transport block of the random access response based on the determination and the first network node being the first UE type.

Additionally, or alternatively, the communications manager 620 may support wireless communication at a first network node (e.g., the device 605) in accordance with examples as disclosed herein. The control message component 640 may be configured as or otherwise support a means for receiving a control message indicating one or more PRACH resources to be used for random access of a second network node, each of the one or more PRACH resources being associated with a respective one or more UE types. The UE type component 630 may be configured as or otherwise support a means for determining that none of the one or more PRACH resources included in the control message are associated with a first UE type, where the first network node is of the first UE type, and where the first UE type is an eRedCap UE type. The selection component 645 may be configured as or otherwise support a means for selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources. The random access request component 650 may be configured as or otherwise support a means for transmitting the random access preamble to the second network node via the selected PRACH resource of the one or more PRACH resources.

Additionally, or alternatively, the communications manager 620 may support wireless communication at a first network node (e.g., the device 605) in accordance with examples as disclosed herein. The control message component 640 may be configured as or otherwise support a means for receiving a control message indicating one or more initial bandwidth parts to be used for random access of a second network node, each of the one or more initial bandwidth parts being associated with a respective one or more UE types. The UE type component 630 may be configured as or otherwise support a means for determining that none of the one or more initial bandwidth parts included in the control message are associated with a first UE type, where the first network node is of the first UE type, and where the first UE type is an eRedCap UE type. The selection component 645 may be configured as or otherwise support a means for selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts. The random access request component 650 may be configured as or otherwise support a means for transmitting a random access request to the second network node via the selected initial bandwidth part of the one or more initial bandwidth parts.

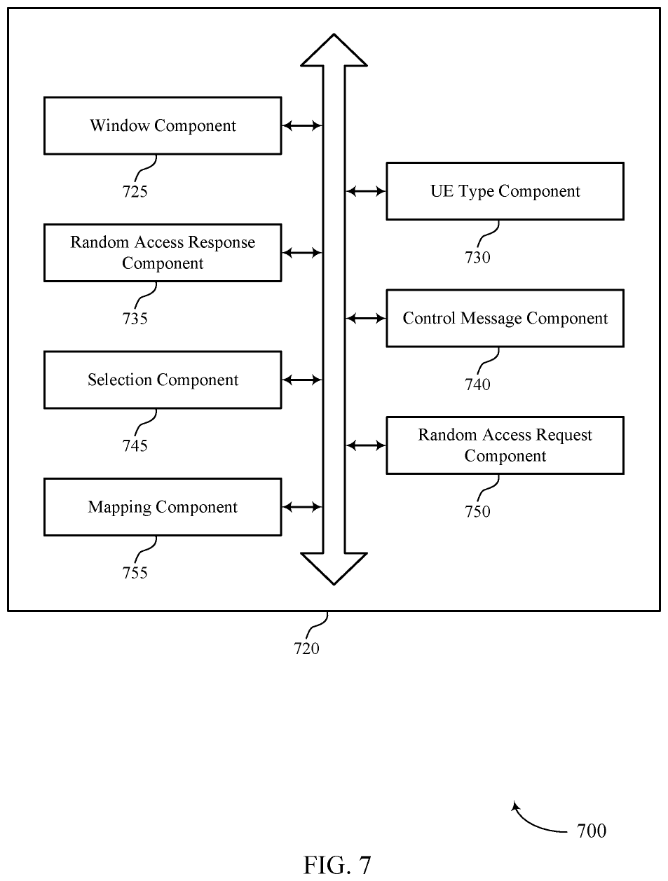

FIG. 7 shows a block diagram 700 of a communications manager 720 that supports random access response schemes for eRedCap UEs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of random access response schemes for eRedCap UEs as described herein. For example, the communications manager 720 may include a window component 725, a UE type component 730, a random access response component 735, a control message component 740, a selection component 745, a random access request component 750, a mapping component 755, or any combination thereof. Each of these components may communicate, directly or indirectly, with one another (e.g., via one or more buses).

The communications manager 720 may support wireless communication at a first network node in accordance with examples as disclosed herein. The window component 725 may be configured as or otherwise support a means for receiving a random access response from a second network node during a random access window associated with a random access request by the first network node. The UE type component 730 may be configured as or otherwise support a means for determining that the random access response is associated with a first UE type. The random access response component 735 may be configured as or otherwise support a means for decoding a transport block of the random access response based on the determination and the first network node being the first UE type.

In some examples, to support determining that the random access response is associated with the first UE type, the random access response component 735 may be configured as or otherwise support a means for determining that the random access response includes a downlink control channel message that includes UE type information indicative of one or more UE types with which the downlink control channel message is associated, where the one or more UE types includes the first UE type.

In some examples, the UE type information includes respective UE type information for each respective UE type of the one or more UE types, and the mapping component 755 may be configured as or otherwise support a means for receiving mapping information that maps each respective UE type information of the UE type information to a respective UE type of the one or more UE types.

In some examples, to support receiving the mapping information, the mapping component 755 may be configured as or otherwise support a means for receiving a system information message or a handover command, where the system information message or the handover command includes the mapping information. In some examples, at least one of the respective UE type information of the UE type information corresponds to a group of different UE types.

In some examples, to support receiving the random access response from the second network node during the random access window, the window component 725 may be configured as or otherwise support a means for receiving the random access response after one or more other random access responses are received during the random access window.

In some examples, first information included in a first MCS level field in the downlink control channel message indicates that the random access response is associated with the first UE type. In some examples, second information included in a second MCS level field in the downlink control channel message indicates a MCS level for the transport block of the random access response.

In some examples, first information included in a first transport block scaling field in the downlink control channel message indicates that the random access response is associated with the first UE type. In some examples, second information included in a second transport block scaling field in the downlink control channel message indicates a transport block scaling value for the transport block of the random access response.

In some examples, to support determining that the random access response is associated with the first UE type, the UE type component 730 may be configured as or otherwise support a means for determining that the random access response includes a downlink control channel message that includes UE type information included in a MCS level field or in a transport block scaling field, the UE type information indicative of the first UE type.

In some examples, to support determining that the random access response is associated with the first UE type, the UE type component 730 may be configured as or otherwise support a means for determining that the random access response includes a CRC value that is scrambled by an RNTI that is associated with the first UE type. In some examples, the RNTI is based on an index value associated with the first UE type.

In some examples, the index value is one of a set of multiple index values. In some examples, each respective index value of the set of multiple index values is associated with a respective UE type of a set of multiple UE types. In some examples, the set of multiple UE types includes the first UE type. In some examples, the index value is non-zero. In some examples, the random access request component 750 may be configured as or otherwise support a means for transmitting, included in the random access request, an indication that the first network node is of the first UE type.

In some examples, the eRedCap UE type corresponds to reduced capabilities with respect to a RedCap UE type and an eMBB UE type. In some examples, the first UE type is associated with a first maximum bandwidth processing capability that is lower than a second maximum bandwidth processing capability associated with eMBB UEs. In some examples, the first maximum bandwidth processing capability pertains to one or more combinations of radio frequency bandwidth, baseband bandwidth, or bandwidth for PDSCH or PUSCH.

Additionally, or alternatively, the communications manager 720 may support wireless communication at a first network node in accordance with examples as disclosed herein. The control message component 740 may be configured as or otherwise support a means for receiving a control message indicating one or more PRACH resources to be used for random access of a second network node, each of the one or more PRACH resources being associated with a respective one or more UE types. In some examples, the UE type component 730 may be configured as or otherwise support a means for determining that none of the one or more PRACH resources included in the control message are associated with a first UE type, where the first network node is of the first UE type, and where the first UE type is an eRedCap UE type. The selection component 745 may be configured as or otherwise support a means for selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources. The random access request component 750 may be configured as or otherwise support a means for transmitting the random access preamble to the second network node via the selected PRACH resource of the one or more PRACH resources.

In some examples, the ranking prioritizes PRACH resources associated with a second UE type when none of the one or more PRACH resources included in the control message are associated with the first UE type. In some examples, the ranking prioritizes a default PRACH resource when none of the one or more PRACH resources included in the control message are associated with the first UE type and none of the one or more PRACH resources included in the control message are associated with the second UE type. In some examples, the ranking prioritizes PRACH resources associated with a third UE type when none of the one or more PRACH resources included in the control message are associated with the first UE type and none of the one or more PRACH resources included in the control message are associated with the second UE type.

In some examples, the second UE type is a RedCap UE type and the third UE type is an eMBB UE type. In some examples, the eRedCap UE type corresponds to reduced capabilities with respect to a RedCap UE type and an eMBB UE type. In some examples, the first UE type is associated with a first maximum bandwidth processing capability that is lower than a second maximum bandwidth processing capability associated with eMBB UEs. In some examples, the first maximum bandwidth processing capability pertains to one or more combinations of radio frequency bandwidth, baseband bandwidth, or bandwidth for PDSCH or PUSCH.

In some examples, the control message component 740 may be configured as or otherwise support a means for receiving a second control message indicating the ranking for the PRACH resource selection.

Additionally, or alternatively, the communications manager 720 may support wireless communication at a first network node in accordance with examples as disclosed herein. The control message component 740 may be configured as or otherwise support a means for receiving a control message indicating one or more initial bandwidth parts to be used for random access of a second network node, each of the one or more initial bandwidth parts being associated with a respective one or more UE types. In some examples, the UE type component 730 may be configured as or otherwise support a means for determining that none of the one or more initial bandwidth parts included in the control message are associated with a first UE type, where the first network node is of the first UE type, and where the first UE type is an eRedCap UE type. The selection component 745 may be configured as or otherwise support a means for selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts. The random access request component 750 may be configured as or otherwise support a means for transmitting a random access request to the second network node via the selected initial bandwidth part of the one or more initial bandwidth parts.

In some examples, the ranking prioritizes initial bandwidth parts associated with a second UE type when none of the one or more initial bandwidth parts included in the control message are associated with the first UE type. In some examples, the ranking prioritizes a default initial bandwidth part when none of the one or more initial bandwidth parts included in the control message are associated with the first UE type and none of the one or more initial bandwidth parts included in the control message are associated with the second UE type. In some examples, the ranking prioritizes initial bandwidth parts associated with a third UE type when none of the one or more initial bandwidth parts included in the control message are associated with the first UE type and none of the one or more initial bandwidth parts included in the control message are associated with the second UE type.

In some examples, the second UE type is a RedCap UE type and the third UE type is an eMBB UE type. In some examples, the eRedCap UE type corresponds to reduced capabilities with respect to a RedCap UE type and an eMBB UE type. In some examples, the first UE type is associated with a first maximum bandwidth processing capability that is lower than a second maximum bandwidth processing capability associated with eMBB UEs. In some examples, the first maximum bandwidth processing capability pertains to one or more combinations of radio frequency bandwidth, baseband bandwidth, or bandwidth for PDSCH or PUSCH.

In some examples, the control message component 740 may be configured as or otherwise support a means for receiving a second control message indicating the ranking for the initial bandwidth part selection.

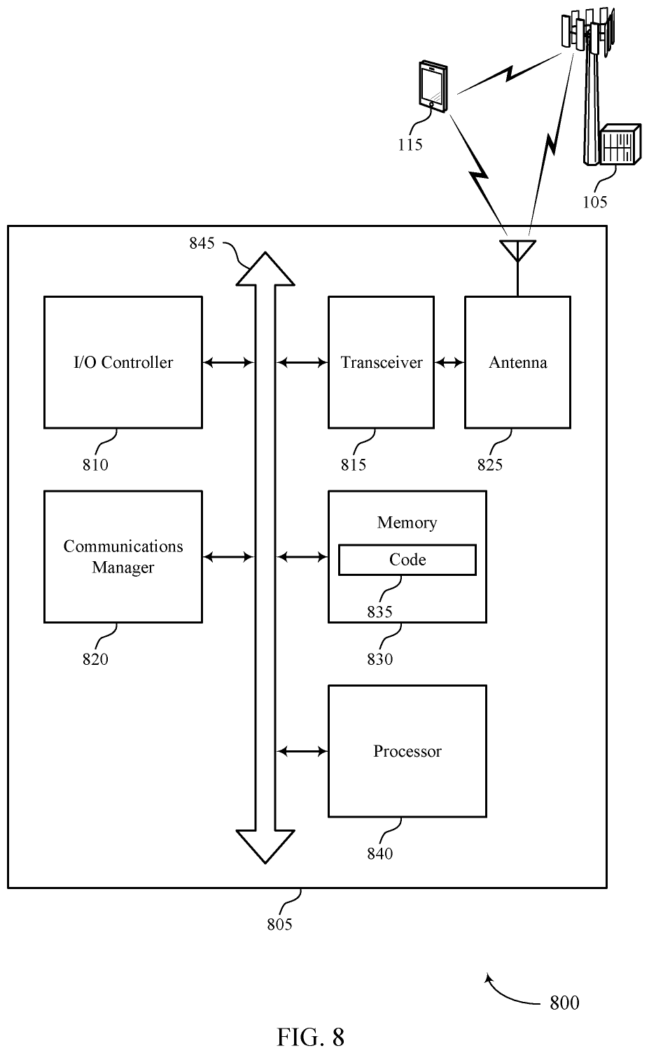

FIG. 8 shows a diagram of a system 800 including a device 805 that supports random access response schemes for eRedCap UEs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting random access response schemes for eRedCap UEs). For example, the device 805 or a component of the device 805 may include a processor 840 and memory 830 coupled with or to the processor 840, the processor 840 and memory 830 configured to perform various functions described herein.

The communications manager 820 may support wireless communication at a first network node (e.g., the device 805) in accordance with examples as disclosed herein. For example, the communications manager 820 may be configured as or otherwise support a means for receiving a random access response from a second network node during a random access window associated with a random access request by the first network node. The communications manager 820 may be configured as or otherwise support a means for determining that the random access response is associated with a first UE type. The communications manager 820 may be configured as or otherwise support a means for decoding a transport block of the random access response based on the determination and the first network node being the first UE type.

Additionally, or alternatively, the communications manager 820 may support wireless communication at a first network node (e.g., the device 805) in accordance with examples as disclosed herein. For example, the communications manager 820 may be configured as or otherwise support a means for receiving a control message indicating one or more initial bandwidth parts to be used for random access of a second network node, each of the one or more initial bandwidth parts being associated with a respective one or more UE types. The communications manager 820 may be configured as or otherwise support a means for determining that none of the one or more initial bandwidth parts included in the control message are associated with a first UE type, where the first network node is of the first UE type, and where the first UE type is an eRedCap UE type. The communications manager 820 may be configured as or otherwise support a means for selecting, in accordance with a rule for initial bandwidth part selection when none of the one or more initial bandwidth parts included in the control message are associated with the first UE type, a particular initial bandwidth part of the one or more initial bandwidth parts included in the control message for use in a random access procedure with the second network node. The communications manager 820 may be configured as or otherwise support a means for transmitting a random access request to the second network node via the selected one of the one or more initial bandwidth parts.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of random access response schemes for eRedCap UEs as described herein, or the processor 840 and the memory 830 may be otherwise configured to perform or support such operations.

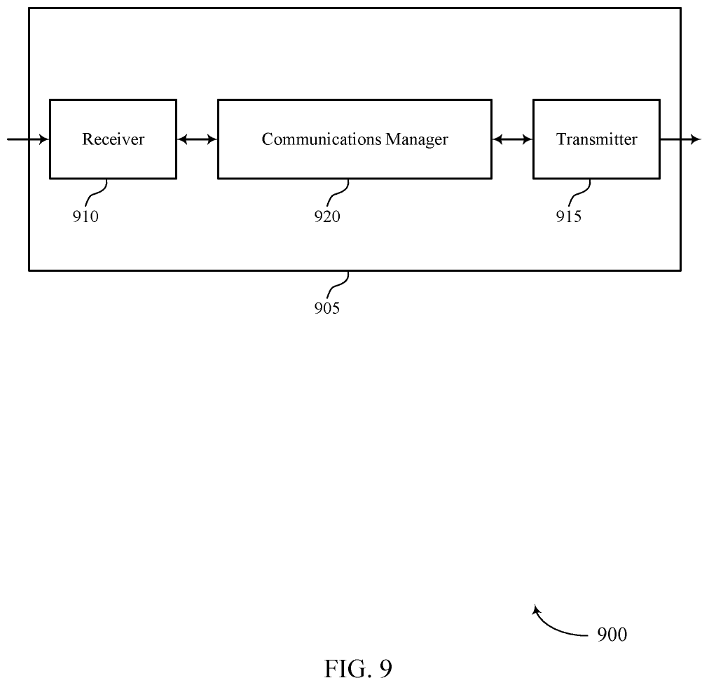

FIG. 9 shows a block diagram 900 of a device 905 that supports random access response schemes for eRedCap UEs in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., UQ samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of random access response schemes for eRedCap UEs as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at first network node (e.g., the device 905) in accordance with examples as disclosed herein. For example, the communications manager 920 may be configured as or otherwise support a means for receiving a random access request from a second network node. The communications manager 920 may be configured as or otherwise support a means for determining that the second network node is associated with a first UE type. The communications manager 920 may be configured as or otherwise support a means for transmitting, based on the second network node being associated with the first UE type, a random access response in response to the random access request, the random access response indicative that the random access response is for UEs of the first UE type.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

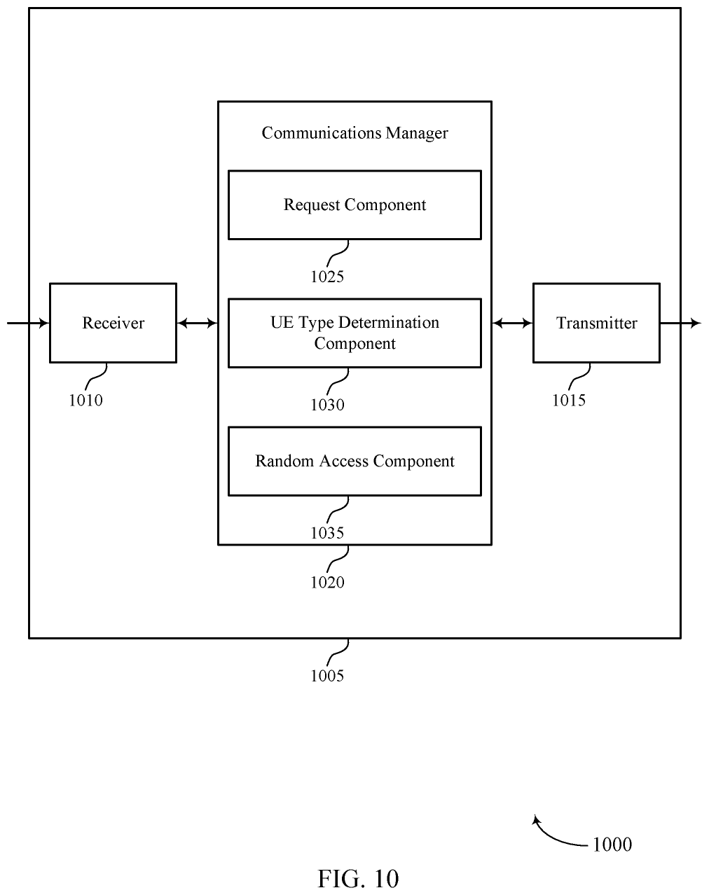

FIG. 10 shows a block diagram 1000 of a device 1005 that supports random access response schemes for eRedCap UEs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., UQ samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., UQ samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of random access response schemes for eRedCap UEs as described herein. For example, the communications manager 1020 may include a request component 1025, a UE type determination component 1030, a random access component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at first network node (e.g., the device 1005) in accordance with examples as disclosed herein. The request component 1025 may be configured as or otherwise support a means for receiving a random access request from a second network node. The UE type determination component 1030 may be configured as or otherwise support a means for determining that the second network node is associated with a first UE type. The random access component 1035 may be configured as or otherwise support a means for transmitting, based on the second network node being associated with the first UE type, a random access response in response to the random access request, the random access response indicative that the random access response is for UEs of the first UE type.

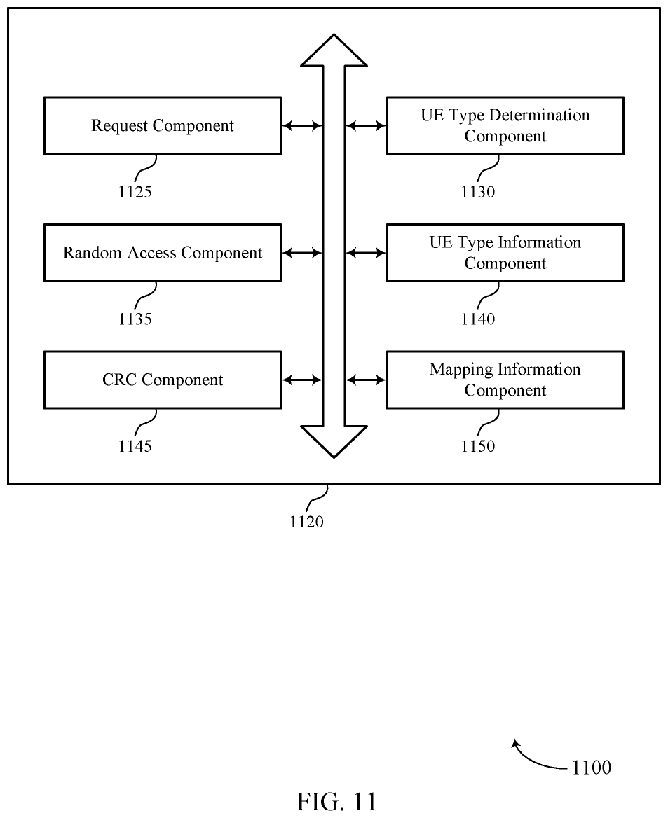

FIG. 11 shows a block diagram 1100 of a communications manager 1120 that supports random access response schemes for eRedCap UEs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of random access response schemes for eRedCap UEs as described herein. For example, the communications manager 1120 may include a request component 1125, a UE type determination component 1130, a random access component 1135, a UE type information component 1140, a CRC component 1145, a mapping information component 1150, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at first network node in accordance with examples as disclosed herein. The request component 1125 may be configured as or otherwise support a means for receiving a random access request from a second network node. The UE type determination component 1130 may be configured as or otherwise support a means for determining that the second network node is associated with a first UE type. The random access component 1135 may be configured as or otherwise support a means for transmitting, based on the second network node being associated with the first UE type, a random access response in response to the random access request, the random access response indicative that the random access response is for UEs of the first UE type.

In some examples, the random access component 1135 may be configured as or otherwise support a means for including, as part of the random access response, a downlink control channel message that includes UE type information indicative of one or more UE types with which the downlink control channel message is associated, where the one or more UE types includes the first UE type.

In some examples, the UE type information includes respective UE type information for each respective UE type of the one or more UE types, and the mapping information component 1150 may be configured as or otherwise support a means for transmitting mapping information that maps each respective UE type information of the UE type information to a respective UE type of the one or more UE types.

In some examples, to support transmitting the mapping information, the mapping information component 1150 may be configured as or otherwise support a means for transmitting a system information message or a handover command, where the system information message or the handover command includes the mapping information. In some examples, at least one of the respective UE type information of the UE type information corresponds to a group of different UE types.

In some examples, to support transmitting the random access response, the random access component 1135 may be configured as or otherwise support a means for transmitting the random access response during a random access window after transmission of one or more other random access responses during the random access window.

In some examples, first information included in a first MCS level field in the downlink control channel message indicates that the random access response is associated with the first UE type. In some examples, second information included in a second MCS level field in the downlink control channel message indicates a MCS level for a transport block of the random access response.

In some examples, first information included in a first transport block scaling field in the downlink control channel message indicates that the random access response is associated with the first UE type. In some examples, second information included in a second transport block scaling field in the downlink control channel message indicates a transport block scaling value for a transport block of the random access response.

In some examples, the UE type information component 1140 may be configured as or otherwise support a means for including, as part of the random access response, a downlink control channel message that includes UE type information included in a MCS level field or in a transport block scaling field, the UE type information indicative of the first UE type.

In some examples, the CRC component 1145 may be configured as or otherwise support a means for scrambling a CRC value of the random access response using an RNTI that is associated with the first UE type. In some examples, the RNTI is based on an index value associated with the first UE type.

In some examples, the index value is one of a set of multiple index values. In some examples, each respective index value of the set of multiple index values is associated with a respective UE type of a set of multiple UE types. In some examples, the set of multiple UE types includes the first UE type. In some examples, the index value is non-zero.

In some examples, to support determining that the second network node is associated with the first UE type, the request component 1125 may be configured as or otherwise support a means for receiving, included in the random access request, an indication that the second network node is of the first UE type.

In some examples, the first UE type is an eRedCap UE type corresponding to reduced capabilities with respect to a RedCap UE type and an eMBB UE type. In some examples, the first UE type is associated with a first maximum bandwidth processing capability that is lower than a second maximum bandwidth processing capability associated with eMBB UEs. In some examples, the first maximum bandwidth processing capability pertains to one or more combinations of radio frequency bandwidth, baseband bandwidth, or bandwidth for PDSCH or PUSCH.

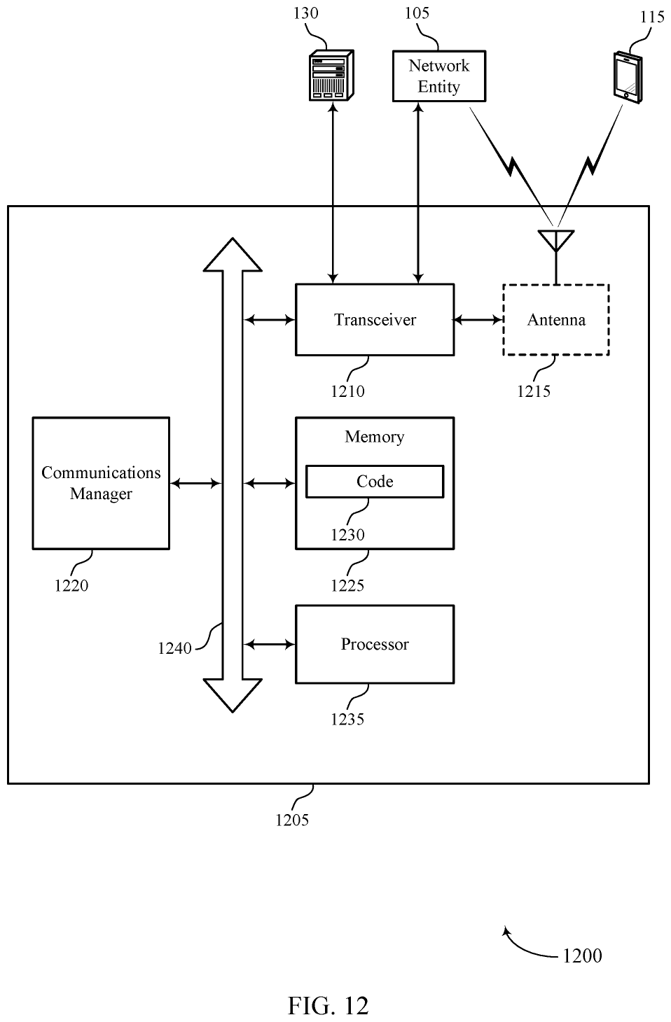

FIG. 12 shows a diagram of a system 1200 including a device 1205 that supports random access response schemes for eRedCap UEs in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting random access response schemes for eRedCap UEs). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at first network node (e.g., the device 1205) in accordance with examples as disclosed herein. For example, the communications manager 1220 may be configured as or otherwise support a means for receiving a random access request from a second network node. The communications manager 1220 may be configured as or otherwise support a means for determining that the second network node is associated with a first UE type. The communications manager 1220 may be configured as or otherwise support a means for transmitting, based on the second network node being associated with the first UE type, a random access response in response to the random access request, the random access response indicative that the random access response is for UEs of the first UE type.

By including or configuring the communications manager 1220 in accordance with examples as described herein, the device 1205 may support techniques for improved communication reliability, reduced latency, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of random access response schemes for eRedCap UEs as described herein, or the processor 1235 and the memory 1225 may be otherwise configured to perform or support such operations.

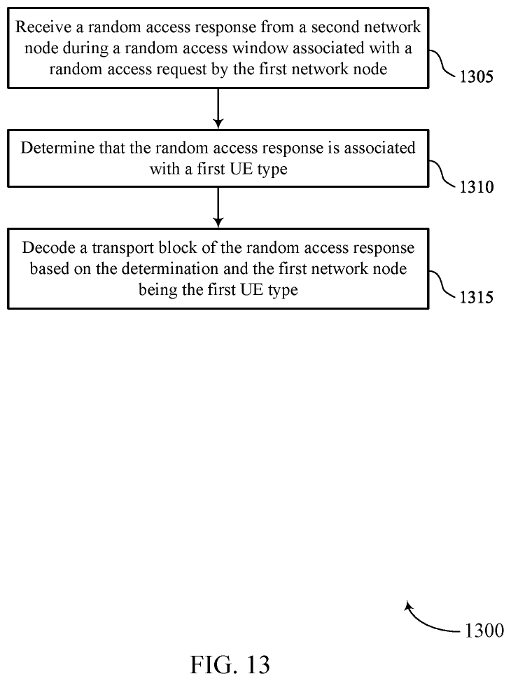

FIG. 13 shows a flowchart illustrating a method 1300 that supports random access response schemes for eRedCap UEs in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware. In the example of FIG. 13, the UE is referred to as a first network node.

At 1305, the method may include receiving a random access response from a second network node during a random access window associated with a random access request by the first network node. The operations of 1305 may be performed in accordance with examples as disclosed herein. In some examples, aspects of the operations of 1305 may be performed by a window component 725 as described with reference to FIG. 7.

At 1310, the method may include determining that the random access response is associated with a first UE type. The operations of 1310 may be performed in accordance with examples as disclosed herein. In some examples, aspects of the operations of 1310 may be performed by a UE type component 730 as described with reference to FIG. 7.

At 1315, the method may include decoding a transport block of the random access response based on the determination and the first network node being the first UE type. The operations of 1315 may be performed in accordance with examples as disclosed herein. In some examples, aspects of the operations of 1315 may be performed by a random access response component 735 as described with reference to FIG. 7.

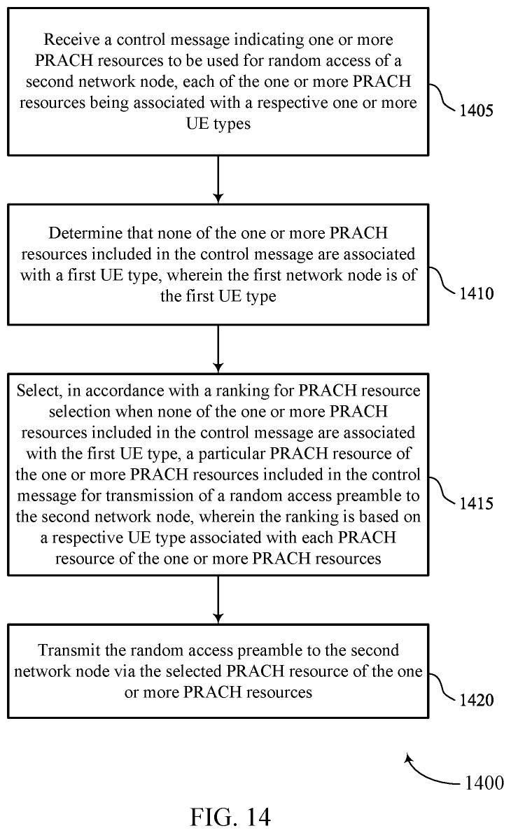

FIG. 14 shows a flowchart illustrating a method 1400 that supports random access response schemes for eRedCap UEs in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware. In the example of FIG. 14, the UE is referred to as a first network node.

At 1405, the method may include receiving a control message indicating one or more PRACH resources to be used for random access of a second network node, each of the one or more PRACH resources being associated with a respective one or more UE types. The operations of 1405 may be performed in accordance with examples as disclosed herein. In some examples, aspects of the operations of 1405 may be performed by a control message component 740 as described with reference to FIG. 7.

At 1410, the method may include determining that none of the one or more PRACH resources included in the control message are associated with a first UE type, where the first network node is of the first UE type, and where the first UE type is an eRedCap UE type. The operations of 1410 may be performed in accordance with examples as disclosed herein. In some examples, aspects of the operations of 1410 may be performed by a UE type component 730 as described with reference to FIG. 7.

At 1415, the method may include selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, where the ranking is based on a respective UE type associated with each PRACH resource of the one or more PRACH resources. The operations of 1415 may be performed in accordance with examples as disclosed herein. In some examples, aspects of the operations of 1415 may be performed by a selection component 745 as described with reference to FIG. 7.

At 1420, the method may include transmitting the random access preamble to the second network node via the selected PRACH resource of the one or more PRACH resources. The operations of 1420 may be performed in accordance with examples as disclosed herein. In some examples, aspects of the operations of 1420 may be performed by a random access request component 750 as described with reference to FIG. 7.

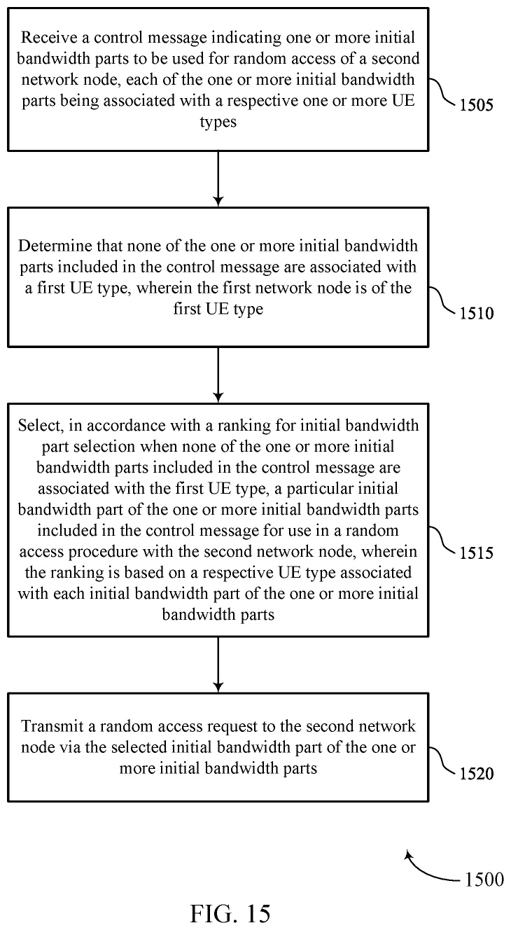

FIG. 15 shows a flowchart illustrating a method 1500 that supports random access response schemes for eRedCap UEs in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware. In the example of FIG. 15, the UE is referred to as a first network node.

At 1505, the method may include receiving a control message indicating one or more initial bandwidth parts to be used for random access of a second network node, each of the one or more initial bandwidth parts being associated with a respective one or more UE types. The operations of 1505 may be performed in accordance with examples as disclosed herein. In some examples, aspects of the operations of 1505 may be performed by a control message component 740 as described with reference to FIG. 7.

At 1510, the method may include determining that none of the one or more initial bandwidth parts included in the control message are associated with a first UE type, where the first network node is of the first UE type, and where the first UE type is an eRedCap UE type. The operations of 1510 may be performed in accordance with examples as disclosed herein. In some examples, aspects of the operations of 1510 may be performed by a UE type component 730 as described with reference to FIG. 7.

At 1515, the method may include selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, where the ranking is based on a respective UE type associated with each initial bandwidth part of the one or more initial bandwidth parts. The operations of 1515 may be performed in accordance with examples as disclosed herein. In some examples, aspects of the operations of 1515 may be performed by a selection component 745 as described with reference to FIG. 7.

At 1520, the method may include transmitting a random access request to the second network node via the selected initial bandwidth part of the one or more initial bandwidth parts. The operations of 1520 may be performed in accordance with examples as disclosed herein. In some examples, aspects of the operations of 1520 may be performed by a random access request component 750 as described with reference to FIG. 7.

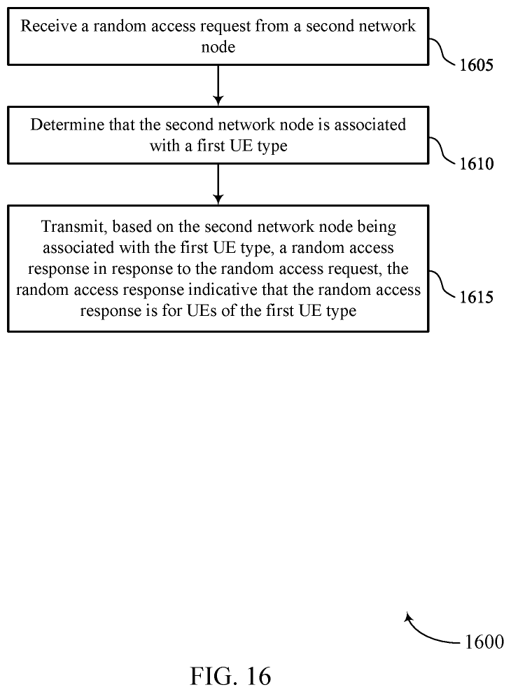

FIG. 16 shows a flowchart illustrating a method 1600 that supports random access response schemes for eRedCap UEs in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving a random access request from a second network node. The operations of 1605 may be performed in accordance with examples as disclosed herein. In some examples, aspects of the operations of 1605 may be performed by a request component 1125 as described with reference to FIG. 11.

At 1610, the method may include determining that the second network node is associated with a first UE type. The operations of 1610 may be performed in accordance with examples as disclosed herein. In some examples, aspects of the operations of 1610 may be performed by a UE type determination component 1130 as described with reference to FIG. 11.

At 1615, the method may include transmitting, based on the second network node being associated with the first UE type, a random access response in response to the random access request, the random access response indicative that the random access response is for UEs of the first UE type. The operations of 1615 may be performed in accordance with examples as disclosed herein. In some examples, aspects of the operations of 1615 may be performed by a random access component 1135 as described with reference to FIG. 11.

The following provides an overview of aspects of the present disclosure:

Aspect 1: A method of wireless communication performed by a first network node, comprising: receiving a control message indicating one or more PRACH resources to be used for random access of a second network node, each of the one or more PRACH resources being associated with a respective one or more UE types; determining that none of the one or more PRACH resources included in the control message are associated with a first UE type, wherein the first network node is of the first UE type, and wherein the first UE type is an eRedCap UE type; selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, wherein the ranking is based on a respective UE type associated with each PRACH resource of the one or more PRACH resources; and transmitting the random access preamble to the second network node via the selected PRACH resource of the one or more PRACH resources.

Aspect 2: The first network node of aspect 1, wherein the ranking prioritizes PRACH resources associated with a second UE type when none of the one or more PRACH resources included in the control message are associated with the first UE type.

Aspect 3: The first network node of aspect 2, wherein the ranking prioritizes a default PRACH resource when none of the one or more PRACH resources included in the control message are associated with the first UE type and none of the one or more PRACH resources included in the control message are associated with the second UE type.

Aspect 4: The first network node of aspect 2, wherein the ranking prioritizes PRACH resources associated with a third UE type when none of the one or more PRACH resources included in the control message are associated with the first UE type and none of the one or more PRACH resources included in the control message are associated with the second UE type.

Aspect 5: The first network node of aspect 4, wherein the second UE type is a RedCap UE type and the third UE type is an eMBB UE type.

Aspect 6: The first network node of any of aspects 1 through 5, wherein the eRedCap UE type corresponds to reduced capabilities with respect to a RedCap UE type and an eMBB UE type.

Aspect 7: The first network node of any of aspects 1 through 6, wherein the first UE type is associated with a first maximum bandwidth processing capability that is lower than a second maximum bandwidth processing capability associated with eMBB UEs.

Aspect 8: The first network node of aspect 7, wherein the first maximum bandwidth processing capability pertains to one or more combinations of radio frequency bandwidth, baseband bandwidth, or bandwidth for PDSCH or PUSCH.

Aspect 9: The method of any of aspects 1 through 8, further comprising: receiving a second control message indicating the ranking for the PRACH resource selection.

Aspect 10: A method of wireless communication performed by a first network node, comprising: receiving a control message indicating one or more initial bandwidth parts to be used for random access of a second network node, each of the one or more initial bandwidth parts being associated with a respective one or more UE types; determining that none of the one or more initial bandwidth parts included in the control message are associated with a first UE type, wherein the first network node is of the first UE type, and wherein the first UE type is an eRedCap UE type; selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, wherein the ranking is based on a respective UE type associated with each initial bandwidth part of the one or more initial bandwidth parts; and transmitting a random access request to the second network node via the selected initial bandwidth part of the one or more initial bandwidth parts.

Aspect 11: The first network node of aspect 10, wherein the ranking prioritizes initial bandwidth parts associated with a second UE type when none of the one or more initial bandwidth parts included in the control message are associated with the first UE type.

Aspect 12: The first network node of aspect 11, wherein the ranking prioritizes a default initial bandwidth part when none of the one or more initial bandwidth parts included in the control message are associated with the first UE type and none of the one or more initial bandwidth parts included in the control message are associated with the second UE type.

Aspect 13: The first network node of aspect 11, wherein the ranking prioritizes initial bandwidth parts associated with a third UE type when none of the one or more initial bandwidth parts included in the control message are associated with the first UE type and none of the one or more initial bandwidth parts included in the control message are associated with the second UE type.

Aspect 14: The first network node of aspect 13, wherein the second UE type is a RedCap UE type and the third UE type is an eMBB UE type.

Aspect 15: The first network node of any of aspects 10 through 14, wherein the eRedCap UE type corresponds to reduced capabilities with respect to a RedCap UE type and an eMBB UE type.

Aspect 16: The first network node of any of aspects 10 through 15, wherein the first UE type is associated with a first maximum bandwidth processing capability that is lower than a second maximum bandwidth processing capability associated with eMBB UEs.

Aspect 17: The first network node of aspect 16, wherein the first maximum bandwidth processing capability pertains to one or more combinations of radio frequency bandwidth, baseband bandwidth, or bandwidth for PDSCH or PUSCH.

Aspect 18: The method of any of aspects 10 through 17, further comprising: receiving a second control message indicating the ranking for the initial bandwidth part selection.

Aspect 19: A first network node comprising a processing system configured to perform a method of any of aspects 1 through 9.

Aspect 20: A first network node comprising at least one means for performing a method of any of aspects 1 through 9.

Aspect 21: A non-transitory computer-readable medium having code for wireless communication stored thereon that, when executed by a network node, causes the network node to perform a method of any of aspects 1 through 9.

Aspect 22: A first network node comprising a processing system configured to perform a method of any of aspects 10 through 18.

Aspect 23: A first network node comprising at least one means for performing a method of any of aspects 10 through 18.

Aspect 24: A non-transitory computer-readable medium having code for wireless communication stored thereon that, when executed by a network node, causes the network node to perform a method of any of aspects 10 through 18.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising a processing system configured to:
receive a control message indicating one or more physical random access channel (PRACH) resources to be used for random access of a second network node, each of the one or more PRACH resources being associated with a respective one or more user equipment (UE) types;
determine that none of the one or more PRACH resources included in the control message are associated with a first UE type, wherein the first network node is of the first UE type, and wherein the first UE type is an enhanced reduced capability UE type;
select, in accordance with a ranking for PRACH resource selection when none of the one or more PRACH resources included in the control message are associated with the first UE type, a particular PRACH resource of the one or more PRACH resources included in the control message for transmission of a random access preamble to the second network node, wherein the ranking is based on a respective UE type associated with each PRACH resource of the one or more PRACH resources; and
transmit the random access preamble to the second network node via the selected PRACH resource of the one or more PRACH resources.

2. The first network node of claim 1, wherein the ranking prioritizes PRACH resources associated with a second UE type when none of the one or more PRACH resources included in the control message are associated with the first UE type.

3. The first network node of claim 2, wherein the ranking prioritizes a default PRACH resource when none of the one or more PRACH resources included in the control message are associated with the first UE type and none of the one or more PRACH resources included in the control message are associated with the second UE type.

4. The first network node of claim 2, wherein the ranking prioritizes PRACH resources associated with a third UE type when none of the one or more PRACH resources included in the control message are associated with the first UE type and none of the one or more PRACH resources included in the control message are associated with the second UE type.

5. The first network node of claim 4, wherein:
the second UE type is a reduced capability UE type, and
the third UE type is an enhanced mobile broadband (eMBB) UE type.

6. The first network node of claim 1, wherein the enhanced reduced capability UE type corresponds to reduced capabilities with respect to a reduced capability UE type and an enhanced mobile broadband (eMBB) UE type.

7. The first network node of claim 1, wherein the first UE type is associated with a first maximum bandwidth processing capability that is lower than a second maximum bandwidth processing capability associated with enhanced mobile broadband (eMBB) UEs.

8. The first network node of claim 7, wherein the first maximum bandwidth processing capability pertains to one or more combinations of radio frequency bandwidth, baseband bandwidth, or bandwidth for physical downlink shared channel (PDSCH) or physical uplink shared channel (PUSCH).

9. The first network node of claim 1, wherein the processing system is configured to:
receive a second control message indicating the ranking for the PRACH resource selection.

10. A first network node for wireless communication, comprising a processing system configured to:
receive a control message indicating one or more initial bandwidth parts to be used for random access of a second network node, each of the one or more initial bandwidth parts being associated with a respective one or more user equipment (UE) types;
determine that none of the one or more initial bandwidth parts included in the control message are associated with a first UE type, wherein the first network node is of the first UE type, and wherein the first UE type is an enhanced reduced capability UE type;
select, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, wherein the ranking is based on a respective UE type associated with each initial bandwidth part of the one or more initial bandwidth parts; and
transmit a random access request to the second network node via the selected initial bandwidth part of the one or more initial bandwidth parts.

11. The first network node of claim 10, wherein the ranking prioritizes initial bandwidth parts associated with a second UE type when none of the one or more initial bandwidth parts included in the control message are associated with the first UE type.

12. The first network node of claim 11, wherein the ranking prioritizes a default initial bandwidth part when none of the one or more initial bandwidth parts included in the control message are associated with the first UE type and none of the one or more initial bandwidth parts included in the control message are associated with the second UE type.

13. The first network node of claim 11, wherein the ranking prioritizes initial bandwidth parts associated with a third UE type when none of the one or more initial bandwidth parts included in the control message are associated with the first UE type and none of the one or more initial bandwidth parts included in the control message are associated with the second UE type.

14. The first network node of claim 13, wherein:
the second UE type is a reduced capability UE type, and
the third UE type is an enhanced mobile broadband (eMBB) UE type.

15. The first network node of claim 10, wherein the enhanced reduced capability UE type corresponds to reduced capabilities with respect to a reduced capability UE type and an enhanced mobile broadband (eMBB) UE type.

16. The first network node of claim 10, wherein the first UE type is associated with a first maximum bandwidth processing capability that is lower than a second maximum bandwidth processing capability associated with enhanced mobile broadband (eMBB) UEs.

17. The first network node of claim 16, wherein the first maximum bandwidth processing capability pertains to one or more combinations of radio frequency bandwidth, baseband bandwidth, or bandwidth for physical downlink shared channel (PDSCH) or physical uplink shared channel (PUSCH).

18. The first network node of claim 10, wherein the processing system is configured to:
receive a second control message indicating the ranking for the initial bandwidth part selection.

19. A method of wireless communication performed by a first network node, comprising:
receiving a control message indicating one or more physical random access channel (PRACH) resources to be used for random access of a second network node, each of the one or more PRACH resources being associated with a respective one or more user equipment (UE) types;
determining that none of the one or more PRACH resources included in the control message are associated with a first UE type, wherein the first network node is of the first UE type, and wherein the first UE type is an enhanced reduced capability UE type;
selecting, in accordance with a ranking for PRACH resource selection when none of the one or more PRACH resources included in the control message are associated with the first UE type, a particular PRACH resource of the one or more PRACH resources included in the control message for transmission of a random access preamble to the second network node, wherein the ranking is based on a respective UE type associated with each PRACH resource of the one or more PRACH resources; and
transmitting the random access preamble to the second network node via the selected PRACH resource of the one or more PRACH resources.

20. The first network node of claim 19, wherein the ranking prioritizes PRACH resources associated with a second UE type when none of the one or more PRACH resources included in the control message are associated with the first UE type.

21. The first network node of claim 20, wherein the ranking prioritizes a default PRACH resource when none of the one or more PRACH resources included in the control message are associated with the first UE type and none of the one or more PRACH resources included in the control message are associated with the second UE type.

22. The first network node of claim 20, wherein the ranking prioritizes PRACH resources associated with a third UE type when none of the one or more PRACH resources included in the control message are associated with the first UE type and none of the one or more PRACH resources included in the control message are associated with the second UE type.

23. The first network node of claim 22, wherein:
the second UE type is a reduced capability UE type, and
the third UE type is an enhanced mobile broadband (eMBB) UE type.

24. The first network node of claim 19, wherein the enhanced reduced capability UE type corresponds to reduced capabilities with respect to a reduced capability UE type and an enhanced mobile broadband (eMBB) UE type.

25. A method of wireless communication performed by a first network node, comprising:
receiving a control message indicating one or more initial bandwidth parts to be used for random access of a second network node, each of the one or more initial bandwidth parts being associated with a respective one or more user equipment (UE) types;
determining that none of the one or more initial bandwidth parts included in the control message are associated with a first UE type, wherein the first network node is of the first UE type, and wherein the first UE type is an enhanced reduced capability UE type;
selecting, in accordance with a ranking for initial bandwidth part selection when none of the one or more initial bandwidth parts included in the control message are associated with the first UE type, a particular initial bandwidth part of the one or more initial bandwidth parts included in the control message for use in a random access procedure with the second network node, wherein the ranking is based on a respective UE type associated with each initial bandwidth part of the one or more initial bandwidth parts; and
transmitting a random access request to the second network node via the selected initial bandwidth part of the one or more initial bandwidth parts.

26. The first network node of claim 25, wherein the ranking prioritizes initial bandwidth parts associated with a second UE type when none of the one or more initial bandwidth parts included in the control message are associated with the first UE type.

27. The first network node of claim 26, wherein the ranking prioritizes a default initial bandwidth part when none of the one or more initial bandwidth parts included in the control message are associated with the first UE type and none of the one or more initial bandwidth parts included in the control message are associated with the second UE type.

28. The first network node of claim 26, wherein the ranking prioritizes initial bandwidth parts associated with a third UE type when none of the one or more initial bandwidth parts included in the control message are associated with the first UE type and none of the one or more initial bandwidth parts included in the control message are associated with the second UE type.

29. The first network node of claim 28, wherein:
the second UE type is a reduced capability UE type, and
the third UE type is an enhanced mobile broadband (eMBB) UE type.

30. The first network node of claim 25, wherein the enhanced reduced capability UE type corresponds to reduced capabilities with respect to a reduced capability UE type and an enhanced mobile broadband (eMBB) UE type.
